(19) United States
(12) Patent Application Publication
(10) Pub. No.: US 2022/0036169 A1
(43) Pub. Date: Feb. 3, 2022

(54) SYSTOLIC COMPUTATIONAL ARCHITECTURE FOR IMPLEMENTING ARTIFICIAL NEURAL NETWORKS PROCESSING A PLURALITY OF TYPES OF CONVOLUTION

(71) Applicant: COMMISSARIAT A L'ENERGIE ATOMIQUE ET AUX ENERGIES ALTERNATIVES, PARIS (FR)

(72) Inventor: Michel HARRAND, GRENOBLE (FR)

(21) Appl. No.: 17/389,410

(22) Filed: Jul. 30, 2021

(30) Foreign Application Priority Data
Aug. 3, 2020 (FR) 2008234

(51) Int. Cl. G06N 3/063; G06N 3/04

(52) U.S. Cl. CPC G06N 3/063; G06N 3/04

(57) ABSTRACT

A circuit for computing output data of a layer of an artificial neural network includes an external memory and an integrated system on chip comprising: a computing network comprising at least one set of at least one group of computing units; the computing network furthermore comprising a buffer memory connected to the computing unit; a weight-storing stage comprising a plurality of memories for storing the synaptic coefficients; each memory being connected to all the computing units of same rank; control means configured to distribute the input data such that each set of groups of computing units receives a column vector of the submatrix stored in the buffer memory implemented by one column. All the sets simultaneously receive column vectors that are shifted with respect to each other by a number of rows equal to a stride of the convolution operation.

### CROSS-REFERENCE TO RELATED APPLICATIONS

This application claims priority to foreign French patent application No. FR 2008234, filed on Aug. 3, 2020, the disclosure of which is incorporated by reference in its entirety.

### FIELD OF THE INVENTION

The invention generally relates to neuromorphic digital networks and more particularly to a computer architecture for the computation of artificial neural networks based on convolutional layers.

### BACKGROUND

Artificial neural networks are computational models that imitate the operation of biological neural networks. Artificial neural networks comprise neurons that are interconnected by synapses, which are for example implemented via digital memories. Artificial neural networks are used in various fields in which (visual, audio, inter alia) signals are processed, such as for example the field of image classification or of image recognition.

Convolutional neural networks correspond to one particular artificial-neural-network model. Convolutional neural networks were initially described in the article by K. Fukushima, “Neocognitron: A self-organizing neural network model for a mechanism of pattern recognition unaffected by shift in position. Biological Cybernetics, 36(4):193-202, 1980. ISSN 0340-1200. doi: 10.1007/BF00344251”.

Convolutional neural networks (also designated deep (convolutional) neural networks or even ConvNets) are neural networks inspired by biological visual systems.

Convolutional neural networks (CNN) are especially used in image classification systems to improve classification. Applied to recognition of images, these networks allow intermediate representations of objects in the images that are smaller and generalisable to similar objects to be learned, this facilitating their recognition. However, the intrinsically parallel operation and complexity of classifiers of CNN type make their implementation in on-board systems of limited resources difficult. Specifically, on-board systems are highly constrained with respect to the footprint of the circuit and to power consumption.

Convolutional neural networks are based on a succession of layers of neurons, which may be convolutional layers or fully connected layers (generally at the end of the network). In convolutional layers, only a subset of the neurons of a layer is connected to a subset of the neurons of another layer. Moreover, convolutional neural networks may process a plurality of input channels to generate a plurality of output channels. Each input channel corresponds, for example, to a different matrix of data.

To the input channels are presented input images in matrix form thus forming an input matrix; an output image matrix is obtained on the output channels.

The matrices of synaptic coefficients for a convolutional layer are also called “convolution kernels”.

In particular, convolutional neural networks comprise one or more convolutional layers that are particularly expensive in numbers of operations. The performed operations are mainly multiply-accumulate (MAC) operations. Moreover, to meet constraints on latency and processing time specific to the targeted applications, it is necessary to parallelise the computations as much as possible.

More particularly, when convolutional neural networks are implemented in an on-board system of limited resources (as opposed to an implementation in the infrastructure of a data centre), decreasing power consumption becomes a criterion that is key to the success of the neural network. In this type of implementation, prior-art solutions employ memories that are external to the computing units. This increases the number of read and write operations carried out between separate electronic chips of the system. These operations of exchanging data between various chips are very energy intensive, for a system dedicated to a mobile application (telephony, autonomous vehicle, robotics, etc.). Specifically, any metal interconnect between a computing unit of the artificial neural network and its external memory (an SRAM or DRAM for example) has a parasitic capacitance with respect to electrical ground of about ten picofarads. Furthermore, integrating a memory block into the integrated circuit containing the computing unit drastically decreases the parasitic capacitance with respect to electrical ground of the link between the two circuits to a few nanofarads. This results in a decrease in the dynamic power consumption of the neural network that is proportional to the sum of all the capacitances of the metal interconnects with respect to electrical ground according to the equation: P_{dyn}=½×C_{L}×VDD²×f with C_{L} the total capacitance of all the electrical interconnects, VDD the supply voltage of the circuit, f the frequency of the circuit and P_{dyn} the dynamic power of the circuit.

There is therefore a need for computers able to implement a convolutional layer of a neural network that would allow the constraints of on-board systems and the targeted applications to be met. More particularly, there is a need to adapt the architectures of neural-network computers with a view to integrating memory blocks into the chip containing the (MAC) computing units, with a view to limiting the distances travelled by computational data and thus to decreasing the consumption of the entirety of the neural network, while limiting the number of write operations to said memories.

Among the advantages of the solution provided by the invention, mention may be made of the ability to carry out multiple types of convolution with the same operator while economising, with respect to prior-art systems, on the technical means required to store partial results. The technical solution according to the invention thus allows exchanges of data between computing units and data memories to be decreased via a localised management of these exchanges that is dependent on the type of convolution.

In addition, the organisation of the data flows input into the computations carried out for a convolutional layer is something that is crucial to minimising the exchanges of data between memories storing these input data and the units for computing output data of a layer of neurons of the network.

The publication “Eyeriss: A Spatial Architecture for Energy-Efficient Dataflow for Convolutional Neural Networks” by Chen et al. presents a convolutional-neural-network computer that implements techniques that introduce parallelism into convolutional-layer computations allowing the power consumption of the circuit to be minimised. However, the solution presented by Chen is effective only with 3×3 convolution operations with a stride equal to 1, thus greatly limiting use of the solution and making implementation with other types of convolution complex.

### SUMMARY OF THE INVENTION

The invention proposes a computer architecture allowing the power consumption of a neural network implemented on a chip to be decreased, and the number of read and write accesses between the computing units of the computer and external memories to be limited. The invention provides a computer architecture for an artificial-neural-network accelerator such that all of the memories containing the synaptic coefficients are located on the same chip containing the computing units of the layers of neurons of the network. The architecture according to the invention has a configurational flexibility that allows computations to be carried out with a plurality of types of convolution depending on the (kernel) size and the stride of the convolution filter. Moreover, the solutions provided in the prior art are dedicated to a limited set of types of convolution, generally convolutions of 3×3 size. The prior-art architectures are not intended for internal weight memories limiting the consumption of the neural-network computer such as described in the invention. The computer according to the invention also allows buffer memories containing the synaptic coefficients and which exchange data with a central weight memory to be used. The association of this configurational flexibility and of a suitable distribution of the synaptic coefficients to internal weight memories allows many computational operations to be executed in an inference phase or a learning phase. Thus, the architecture provided by the invention minimises the exchanges of data between the computing units and external memories or memories located at a relatively large distance from the system on chip. This results in an improvement in the power consumption of the neural-network computer located on-board a mobile system. The accelerator computer architecture according to the invention is compatible with emergent memory technologies such as emergent nonvolatile-memory (NVM) technologies requiring a limited number of write operations.

The subject of the invention is a computing circuit for computing output data of a layer of an artificial neural network from input data. The neural network is composed of a succession of layers each consisting of a set of neurons. Each layer is connected to an adjacent layer via a plurality of synapses associated with a set of synaptic coefficients forming at least one weight matrix;

the computing network (CALC) comprising:

an external memory for storing all the input and output data of all the neurons of at least one layer of the network in the course of computation;

an integrated system on chip comprising:

i. a computing network comprising at least one set of at least one group of computing units of rank j=0 to M with M a positive integer; each group comprising at least one computing unit of rank n=0 to N with N a positive integer for computing a sum of input data weighted by the synaptic coefficients;
the computing network further comprising a buffer memory for storing a subset of input data originating from the memory; the buffer memory being connected to the computing units;
ii. a weight-storing stage comprising a plurality of memories of rank n=0 to N for storing the synaptic coefficients of the weight matrices; each memory of rank n=0 to N being connected to all the computing units of the same rank n of each of the groups;
iii. control means configured to distribute the input data from the buffer memory to said sets so that each set of groups of computing units receives a column vector of the submatrix stored in the buffer memory incremented by one column with respect to the column vector received previously; all the sets simultaneously receive column vectors that are shifted with respect to each other by a number of rows equal to a stride of the convolution operation.

According to one particular aspect of the invention, the control means are furthermore configured to organise the read-out of the synaptic coefficients from the weight memories to said sets.

According to one particular aspect of the invention, the control means are implemented via a set of address generators.

According to one particular aspect of the invention, the integrated system on chip comprises an internal memory to be used as an extension of the external volatile memory; the internal memory being connected to write to the buffer memory.

According to one particular aspect of the invention, the output data of a layer are organised into a plurality of output matrices of rank q=0 to Q with Q a positive integer, each output matrix being obtained from at least one input matrix of rank p=0 to P with P a positive integer,

for each pair consisting of an input matrix of rank p and an output matrix of rank q, the associated synaptic coefficients form a weight matrix, the computation of an output datum of the output matrix comprising computation of the sum of the input data of a submatrix of the input matrix weighted by the associated synaptic coefficients,
the input submatrices have the same dimensions as the weight matrix and each input submatrix is obtained by applying a shift equal to the stride of the convolution operation carried out in the row or column direction to an adjacent input submatrix.

According to one particular aspect of the invention, each computing unit comprises:

i. an input register for storing an input datum;
ii. a multiplier circuit for computing the product of an input datum and of a synaptic coefficient;
iii. an adder circuit having a first input connected to the output of the multiplier circuit and being configured to perform the operations of summing partial results of computation of a weighted sum;
iv. at least one accumulator for storing the partial or final results of computation of the weighted sum.

According to one particular aspect of the invention, each weight memory of rank n=0 to N contains all of the synaptic coefficients belonging to all the weight matrices associated with the output matrix of rank q=0 to Q such that q modulo N+1 is equal to n.

According to one particular aspect of the invention, the computing circuit introduces a parallelism into computation of output channels, this parallelism being such that the computing units of rank n=0 to N of the various groups of computing units carry out the multiplication and addition operations to compute an output matrix of rank q=0 to Q such that q modulo N+1 is equal to n.

According to one particular aspect of the invention, each set comprises a single group of computing units, each computing unit comprising a plurality of accumulators, each set of rank k with k=1 to K with K a strictly positive integer, for a received input datum, carries out successively the addition and multiplication operations to compute partial output results belonging to a row of rank i=0 to L, with L a positive integer, of the output matrix from said input datum, such that i modulo K is equal to (k−1).

According to one particular aspect of the invention, the partial results of each of the output results of the row of the output matrix computed by a computing unit are stored in a separate accumulator belonging to the same computing unit.

According to one particular aspect of the invention, each set comprises a plurality of groups of computing units introducing a spatial parallelism into computation of the output matrix such that each set of rank k with k=1 to K carries out in parallel the addition and multiplication operations to compute partial output results belonging to a row of rank i of the output matrix, such that i modulo K is equal to (k−1) and such that each group of rank j=0 to M of said set carries out the addition and multiplication operations to compute partial output results belonging to a column of rank I of the output matrix such that I modulo M+1 is equal to j.

According to one particular aspect of the invention, the computing circuit comprises three sets, each set comprising three groups of computing units.

According to one particular aspect of the invention, the weight memories are of NVM type.

### BRIEF DESCRIPTION OF THE DRAWINGS

Other features and advantages of the present invention will become more clearly apparent on reading the following description with reference to the following appended drawings.

FIG. 1 shows an example of a convolutional neural network containing convolutional layers and fully connected layers.

FIG. 2a shows a first illustration of the operation of a convolutional layer of a convolutional neural network with an input channel and an output channel.

FIG. 2b shows a second illustration of the operation of a convolutional layer of a convolutional neural network with an input channel and an output channel.

FIG. 2c shows a third illustration of the operation of a convolutional layer of a convolutional neural network with an input channel and an output channel.

FIG. 2d shows an illustration of the operation of a convolutional layer of a convolutional neural network with a plurality of input channels and a plurality of output channels.

FIG. 3 illustrates a functional schematic of the general architecture of the computing circuit of a convolutional neural network according to the invention.

FIG. 4 illustrates a functional schematic of an example of a computing network implemented in a system on chip according to a first embodiment of the invention.

FIG. 5 illustrates a functional schematic of an example of a computing unit belonging to a group of computing units of the computing network according to one embodiment of the invention.

FIG. 6a shows a first illustration of the convolution operations that may be carried out with spatial parallelism by the computing network according to one embodiment to obtain one portion of the matrix output on an output channel from a matrix input on an input channel during a 3×3s1 convolution.

FIG. 6b shows a second illustration of the convolution operations that may be carried out with spatial parallelism by the computing network according to one embodiment to obtain one portion of the matrix output on an output channel from a matrix input on an input channel during a 3×3s1 convolution.

FIG. 6c shows a third illustration of the convolution operations that may be carried out with spatial parallelism by the computing network according to one embodiment to obtain one portion of the matrix output on an output channel from a matrix input on an input channel during a 3×3s1 convolution.

FIG. 7a illustrates operating steps of a computing network according to a first computing embodiment with “a row parallelism” of the invention, for computing a convolutional layer of 3×3s1 type.

FIG. 7b illustrates operating steps of a computing network according to a second computing embodiment with “a row and column spatial parallelism” of the invention, for computing a convolutional layer of 3×3s1 type.

FIG. 8a shows a first illustration of the convolution operations that may be carried out with a spatial parallelism by the computing network according to one embodiment to obtain one portion of the matrix output on an output channel from a matrix input on an input channel during a 5×5s2 convolution.

FIG. 8b shows a second illustration of the convolution operations that may be carried out with a spatial parallelism by the computing network according to one embodiment to obtain one portion of the matrix output on an output channel from a matrix input on an input channel during a 5×5s2 convolution.

FIG. 8c shows a third illustration of the convolution operations that may be carried out with a spatial parallelism by the computing network according to one embodiment to obtain one portion of the matrix output on an output channel from a matrix input on an input channel during a 5×5s2 convolution.

FIG. 8d shows a fourth illustration of the convolution operations that may be carried out with a spatial parallelism by the computing network according to one embodiment to obtain one portion of the matrix output on an output channel from a matrix input on an input channel during a 5×5s2 convolution.

FIG. 8e shows a fifth illustration of the convolution operations that may be carried out with a spatial parallelism by the computing network according to one embodiment to obtain one portion of the matrix output on an output channel from a matrix input on an input channel during a 5×5s2 convolution.

FIG. 9 illustrates operating steps of a computing network according to a second computing embodiment with “a row and column spatial parallelism” of the invention, for computing a convolutional layer of 5×5s2 type.

FIG. 10a shows the convolution operations that may be carried out with a spatial parallelism by the computing network according to the invention to obtain one portion of the matrix output on an output channel from a matrix input on an input channel during a 3×3s2 convolution.

FIG. 10b shows the convolution operations that may be carried out with a spatial parallelism by the computing network according to the invention to obtain one portion of the matrix output on an output channel from a matrix input on an input channel during a 7×7s2 convolution.

FIG. 10c shows the convolution operations that may be carried out with a spatial parallelism by the computing network according to the invention to obtain one portion of the matrix output on an output channel from a matrix input on an input channel during a 7×7s4 convolution.

FIG. 10d shows the convolution operations that may be carried out with a spatial parallelism by the computing network according to the invention to obtain one portion of the matrix output on an output channel from a matrix input on an input channel during an 11×11s4 convolution.

### DETAILED DESCRIPTION

By way of indication, first one example of the overall structure of a convolutional neural network containing convolutional layers and fully connected layers will be described.

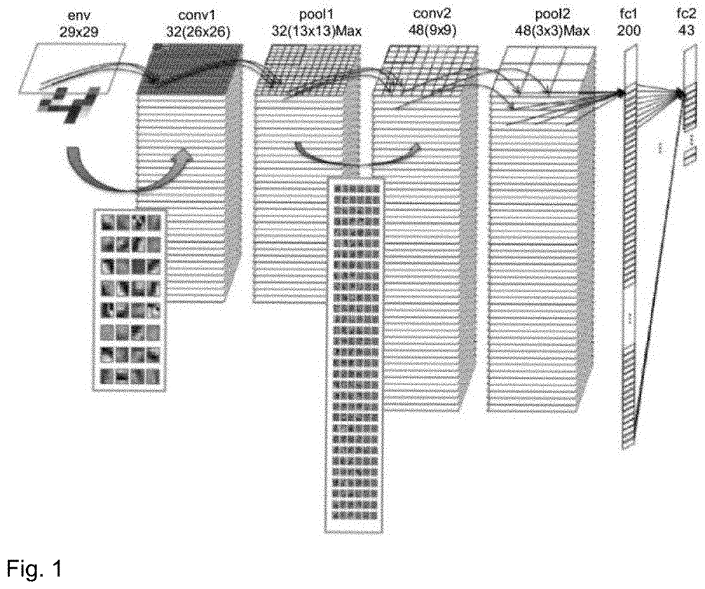

FIG. 1 shows the overall architecture of one example of a convolutional network for image classification. The images at the bottom of FIG. 1 show an extract of the convolution kernels of the first layer. An artificial neural network (also called a “formal” neural network or referred to simply by the expression “neural network” below) consists of one or more layers of neurons, which are interconnected to one another.

Each layer consists of a set of neurons, which are connected to one or more preceding layers. Each neuron of a layer may be connected to one or more neurons of one or more preceding layers. The last layer of the network is called the “output layer”. The neurons are connected to one another by synapses associated with synaptic weights, which weight the efficiency of the connection between the neurons, and form the adjustable parameters of a network. The synaptic weights may be positive or negative.

The neural networks referred to as “convolutional” networks (or even “deep convolutional” networks or “convnets”) are furthermore composed of layers of particular types, such as convolutional layers, pooling layers and fully connected layers. By definition, a convolutional neural network comprises at least one convolutional layer or pooling layer.

The architecture of the accelerator computer circuit according to the invention is compatible with the execution of the computations of convolutional layers. We will first of all start by describing the computations carried out for a convolutional layer.

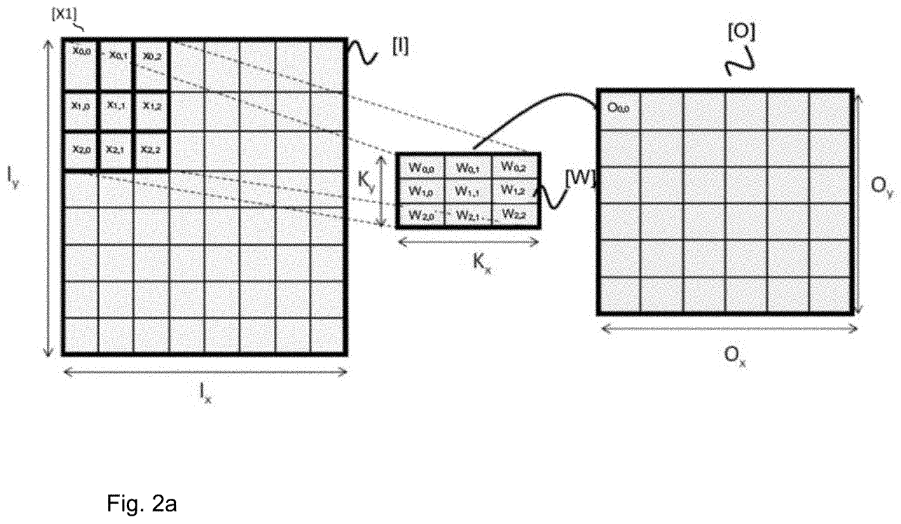

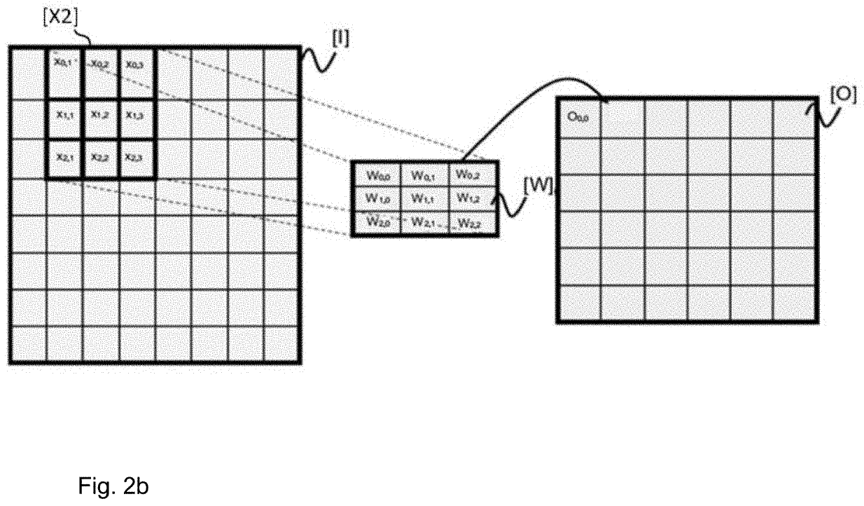

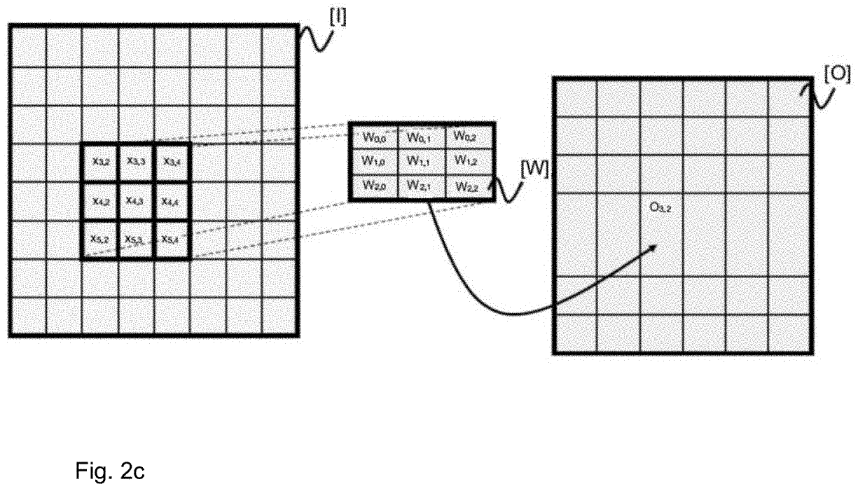

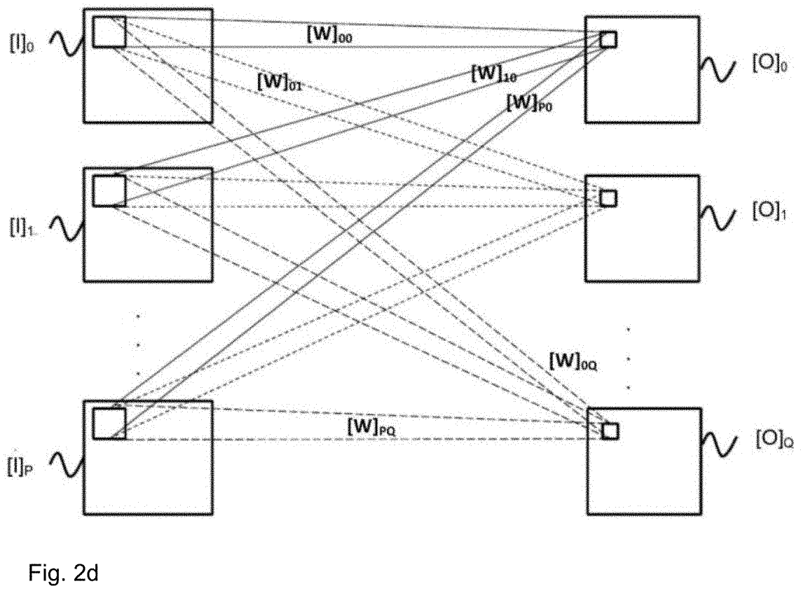

FIGS. 2a-2d illustrate the general operation of a convolutional layer.

FIG. 2a shows an input matrix [I] of size (Iₓ,I_{y}) related to an output matrix [O] of size (Oₓ,O_{y}) via a convolutional layer that carries out a convolution operation using a filter [W] de taille (Kₓ,K_{y}).

A value O_{i,j} of the output matrix [O] (corresponding to the output value of an output neurone) is obtained by applying the filter [W] to the corresponding submatrix of the input matrix [I].

Generally, the convolution operation, of symbol ⊗, is defined between two matrices [X] and [Y] of equal dimensions, these matrices being composed of elements x_{i,j} and y_{i,j}, respectively. The result is the sum of the products of the coefficients x_{i,j}·y_{i,j} of same position in both matrices.

In FIG. 2a, the first value O_{0,0} of the output matrix [O] obtained by applying the filter [W] to the first input submatrix, which is denoted [X1], and which is of dimensions equal to that of the filter [W], has been shown. The detail of the convolution operation is described by the following equation:

O_{0,0}=[X1]⊗[W]

where

O_{0,0}=x₀₀·w₀₀+x₀₁·w₀₁+x₀₂·w₀₂+x₁₀·w₁₀+x₁₁·w₁₁+x₁₂·w₁₂+x₂₀·w₂₀+x₂₁·w₂₁+x₂₂·w₂₂.

In FIG. 2b, the second value O_{0,1} of the output matrix [O] obtained by applying the filter [W] to the second input submatrix, which is denoted [X2], and which is of dimensions equal to that of the filter [W], has been shown. The second input submatrix [X2] is obtained by shifting the first submatrix [X1] by one column. Here, a stride equal to 1 is spoken of.

The detail of the convolution operation used to obtain O_{0,1} is described by the following equation:

O_{0,1}=[X2]⊗[W]

where

O_{0,1}=x₀₁·w₀₀+x₀₂·w₀₁+x₀₃·w₀₂+x₁₁·w₁₀+x₁₂·w₁₁+x₁₃·w₁₂+x₂₁·w₂₀+x₂₂·w₂₁+x_{23·}w₂₂.

FIG. 2c shows a general case of computation of any value O_{3,2} of the output matrix.

Generally, the output matrix [O] is related to the input matrix [1] by a convolution operation, implemented via a convolution kernel or filter denoted [W]. Each neuron of the output matrix [O] is related to one portion of the input matrix [I]; this portion is called the “input submatrix” or even the “neuron receptive field” and it has the same dimensions as the filter [W]. The filter [W] is common to all of the neurons of an output matrix [0].

The values of the output neurons O_{i,j} are obtained via the following relationship:

$${O}_{i , j} = g ( {\sum }_{t = 0}^{( {K}_{x} - 1 )} {\sum }_{l = 0}^{( {K}_{y} - 1 )} {x}_{i . {s}_{i} + t , j . {s}_{j} + l} \cdot {w}_{t , l} )$$

In the above formula, g( ) designates the activation function of the neuron, whereas sᵢ and sⱼ designate vertical and horizontal strides, respectively. A “stride” corresponds to the shift between each application of the convolution kernel to the input matrix. For example, if the stride is larger than or equal to the size of the kernel, then there is no overlap between each application of the kernel. It will be recalled that this formula is valid in the case where the input matrix has been processed to add additional rows and columns (padding). The filter matrix [W] is composed of the synaptic coefficients w_{t,l} of ranks t=0 to Kₓ−1 and l=0 to K_{y}−1.

Generally, each convolutional neuron layer, denoted Cₖ, may receive a plurality of input matrices input on a plurality of input channels of rank p=0 to P with P a positive integer and/or compute a plurality of output matrices output on a plurality of output channels of rank q=0 to Q with Q a positive integer. The filter corresponding to the convolution kernel that relates the output matrix [O]_{q} to the input matrix [I]p in the neuron layer Cₖ will be denoted [W]_{p,q′}^{k}. Various filters may be associated with various input matrices, for the same output matrix.

For the sake of simplicity, the activation function go has not been shown in FIGS. 2a-2d.

FIGS. 2a-2c illustrates a case where a single output matrix (and therefore a single output channel) [O] is connected to a single input matrix [I] (and therefore a single input channel).

FIG. 2d illustrates another case in which a plurality of output matrices [O]_{q} are each related to a plurality of input matrices [I]p. In this case, each output matrix [O]_{q} of the layer Cₖ is related to each input matrix [I]p via a convolutional kernel [W]_{p,q′}^{k} that may be different depending on the output matrix.

Moreover, when one output matrix is related to a plurality of input matrices, the convolutional layer carries out, in addition to each convolution operation described above, a sum of the neuron output values obtained for each input matrix. In other words, the output value of an output neuron (also called the output channels) is in this case equal to the sum of the output values obtained by each convolution operation applied to each input matrix (also called the input channels).

The values of the output neurons O_{i,j} of the output matrix [O]_{q} are in this case given by the following relationship:

$${O}_{i , j , q} = g ( {\sum }_{p = 0}^{P} {\sum }_{t = 0}^{( {K}_{x} - 1 )} {\sum }_{l = 0}^{( {K}_{y} - 1 )} {x}_{p , i . {s}_{i} + t , j . {s}_{j} + l} \cdot {w}_{p , q , t , l} )$$

with p=0 to P the rank of an input matrix [I]p related to the output matrix [O]_{q} of the layer Cₖ of rank q=0 to Q via the filter [W]_{p,q′}^{k} composed of the synaptic coefficients w_{p,q,t,l} of ranks t=0 to Kₓ−1 and l=0 to K_{y}−1.

Thus, to compute the output result of an output matrix [O]_{q} of rank q of the layer Cₖ it is necessary to determine all of the synaptic coefficients of the weight matrices [W]_{p,q′}^{k} relating all of the input matrices [I]p to the output matrix [O]_{q} of rank q.

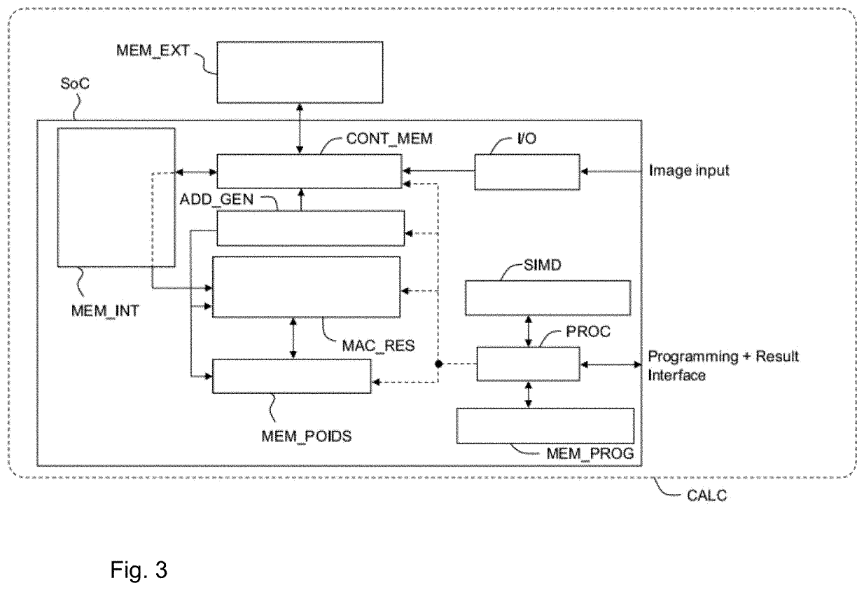

FIG. 3 illustrates an example of a functional diagram of the general architecture of the computing circuit of a convolutional neural network according to the invention.

The computing circuit CALC of a convolutional neural network comprises an external volatile memory MEM_EXT for storing the input and output data of all the neurons of at least one layer of the neural network in the course of computation during an inference or learning phase and an integrated system on chip SoC.

The integrated system SoC comprises a computing network MAC_RES made up of a plurality of computing units for computing neurons of a layer of the neural network, an internal volatile memory MEM_INT for storing the input and output data of the neurons of the layer in the course of computation, a weight-storing stage MEM_POIDS comprising a plurality of internal non-volatile memories of rank n=0 to N denoted MEM_POIDSₙ for storing the synaptic coefficients of the weight matrices, a circuit CONT_MEM for controlling the memories, which is connected to all of the memories MEM_INT, MEM_EXT and MEM_POIDS in order to play the role of interface between the external memory MEM_EXT and the system on chip SoC, a set of address generators ADD_GEN for organising the distribution of data and of the synaptic coefficients in a computing phase and for organising the transfer of the computed results from the various computing units of the computing network MAC_RES to one of the memories MEM_EXT or MEM_INT.

The system on chip SoC especially comprises an image interface, denoted I/O, for receiving the input images of the entirety of the network in an inference or learning phase. It should be noted that the input data received via the I/O interface are not limited to images but may, more generally, be of various natures.

The system on chip SoC also comprises a processor PROC for configuring the computing network MAC_RES and the address generators ADD_GEN depending on the type of computed neural layer and on the computing phase. The processor PROC is connected to an internal nonvolatile memory MEM_PROG that contains a computer program executable by the processor PROC.

Optionally, the system on chip SoC comprises an SIMD computing accelerator (SIMD being the acronym of single instruction, multiple data) connected to the processor PROC to improve the performance of the processor PROC.

The external and internal data memories MEM_EXT and MEM_INT may be the DRAMs.

The internal data memory MEM_INT may be an SRAM.

The processor PROC, the SIMD accelerator, the program memory MEM_PROG, the set of address generators ADD_GEN and the circuit CONT_MEM for controlling the memories form part of means for controlling the computing circuit CALC of a convolutional neural network.

The weight-data memories MEM_POIDSₙ may be memories based on emergent NVM technology.

The invention differs from prior-art solutions in the specific organisation of the computing units in the computing network CALC, which allows computational performance to be improved using techniques for introducing parallelism. It is here a question of the ability to combine a spatial computational parallelism (whereby all of the computing units carry out the computations of various neurons belonging to the same output matrix in parallel) with a channel parallelism (whereby the computations associated with various output channels but having the same input matrix are carried out in parallel). The combination of these two types of parallelism allows the performance of the computer to be improved.

In addition, the invention differs from prior-art solutions in the management of the distribution of the input data to the computing network CALC, which allows exchanges of data with the external memory MEM_EXT to be minimised, and in the advantageous distribution of the synaptic coefficients to the internal weight memories, with a view to decreasing power consumption resulting from external-memory read operations.

In addition, the invention enables configurational flexibility. A first mode of computation, described below, and called “row parallelism” allows any type of convolution to be carried out. A second mode of computation, described below, and called “row and column spatial parallelism” allows a wide range of convolution operations, and especially 3×3 stride1, 3×3 stride2, 5×5 stride1, 7×7 stride2, 1×1 stride1 and 11×11 stride4 convolution operations, to be carried out.

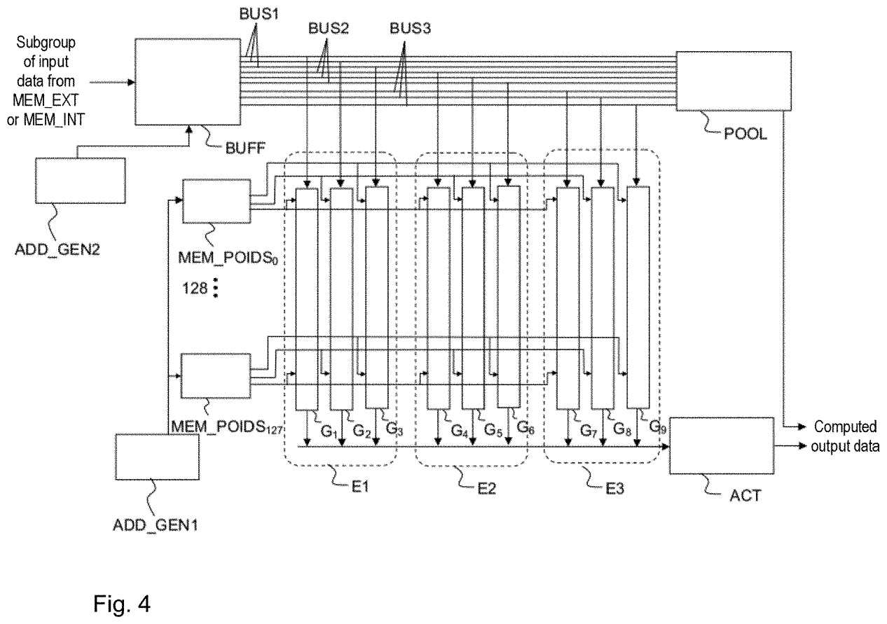

FIG. 4 illustrates an example of a functional schematic of the computing network MAC_RES implemented in the system on chip SoC according to a first embodiment of the invention, allowing a computation to be carried out with “row and column spatial parallelism”. The computing network MAC_RES comprises a plurality of groups of computing units denoted Gⱼ of rank j=0 to M with M a positive integer, each group comprising a plurality of computing units denoted PEₙ of rank n=0 to N with N a positive integer.

Advantageously, the number of groups Gⱼ of computing units is equal to the number of points in a convolution filter (which is equal to the number of convolution operations to be carried out; by way of example 9 for a 3×3 convolution, and 25 for a 5×5 convolution). This structure allows a spatial parallelism to be introduced whereby each group Gⱼ of computing units carries out one convolution computation on one submatrix [X1] per one kernel [W] to obtain one output result O_{i,j}.

Advantageously, the number of computing units PEₙ belonging to the same group, denoted Gⱼ, is equal to the number of output channels of a convolutional layer, allowing the channel parallelism described above to be achieved.

Without loss of generality, the example of implementation illustrated in FIG. 4 comprises 9 groups of computing units; each group comprises 128 computing units denoted PEₙ. This design choice allows a wide range of types of convolution, such as 3×3 stride1, 3×3 stride2, 5×5 stride1, 7×7 stride2, 1×1 stride1 and 11×11 stride4 convolutions, to be carried out, based on the spatial parallelism achieved via the groups of computing units, while nonetheless computing in parallel 128 output channels. An example of the way in which the computations carried out by the computing network MAC_RES are executed depending on these design choices will be described below, by way of indication.

During the computation of a layer of neurons, each of the groups Gⱼ of computing units receives input data xᵢⱼ from a buffer memory integrated into the computing network MAC_RES, which is denoted BUFF. The buffer memory BUFF receives a subset of the input data from the external memory MEM_EXT or from the internal memory MEM_INT. Input data originating from one or more input channels are used to compute one or more output matrices output on one or more output channels.

The buffer memory BUFF is thus a memory of small size used to temporarily store input data used to compute some of the neurons of the layer in the course of computation. This allows the number of exchanges between the computing units and the external or internal memories MEM_EXT and MEM_INT, which are of much larger size, to be minimised. The buffer memory BUFF comprises one write port connected to the memories MEM_EXT or MEM_INT and 9 read ports each connected to one group Gⱼ of computing units. As described above, the system on chip SoC comprises a plurality of weight memories MEM_POIDSₙ of rank n=1 to N. Each weight memory of rank n is connected to all the computing units PEₙ of same rank of the various groups Gⱼ of computing units. More precisely, the weight memory of rank 0 MEM_POIDS₀ is connected to the computing unit PE₀ of the first group G₁ of computing units, but also to the computing unit PE₀ of the second group G₂ of computing units, to the computing unit PE₀ of the third group G₃ of computing units, the computing unit PE₀ of the fourth group G₄ of computing units, and to all the computing units of rank 0 PE₀ belonging to any group Gⱼ. Generally, each weight memory of rank n MEM_POIDSₙ is connected to the computing units of rank n of all the groups Gⱼ of computing units.

Each weight memory of rank n MEM_POIDSₙ contains all the weight matrices [W]_{p,q′}^{k} associated with the synapses connected to all the neurons of the output matrices corresponding to the output channel of given rank n with n an integer varying from 0 to 127 in the example of implementation of FIG. 4.

Alternatively, the weight-memory stage MEM_POIDS may be realised via a single memory connected to all the computing units PEₙ of the computing network MAC_RES and containing synaptic coefficients organised into bit words. The size of a word is equal to the number of computing units PEₙ belonging to a group Gⱼ, multiplied by the size of one weight. In other words, the number of weights contained in a word is equal to the number of computing units PEₙ belonging to a group Gⱼ.

As a result thereof, at the moment when the computation of an output channel of rank q of a layer of neurons is carried out, each synaptic coefficient of the weight matrix [W]_{p,n′}^{k} associated with said output channel is stored solely in the weight memory MEM_POIDSₙ of same rank n=q, when the number of output channels is lower than or equal to the number of weight memories.

More generally, when the number Q of output channels is higher than the number N+1 of weight memories, and at the moment when the computation of an output channel of rank q=0 to Q of a neural layer is carried out, each synaptic coefficient of the weight matrix [W]_{p,n′}^{k} associated with said output channel is stored solely in the weight memory MEM_POIDSₙ of rank n=0 to N+1 such that q modulo N+1 is equal to n.

Alternatively, it is possible to successively load, for each new output channel, the weight memory MEM_POIDSₙ of rank n=0 to N+1 from a central weight memory; with the sequence of matrices [W]_{p,q1′}^{k} [W]_{p,q2′}^{k} [W]_{p,q3′}^{k} respectively associated with the output channels of rank q₁, q₂, q₃ etc, such that q₁<q₂, <q₃, q₁ modulo N+1=n, q₂ modulo N+1=n and q₃ modulo N+1=n etc.

The specific distribution of the synaptic coefficients in the weight memories that was described above allows the synaptic coefficients to be stored in a targeted manner so as to decrease the size of the weight memories MEM_POIDSₙ and therefore to densify the integration of the memories in the integrated computing circuit. This is advantageous in that it minimises the exchanges of data between the computing units and the external memories or memories located at a relatively large distance from the system on chip, and therefore decreases the latency of the system.

The content of the buffer memory BUFF is read by a dedicated address-generator stage that belongs to the set of address generators ADD_GEN.

The content of the internal weight memories MEM_POIDSₙ is read by a dedicated address-generator stage that belongs to the set of address generators ADD_GEN.

Advantageously, the computing network MAC_RES especially comprises a circuit for computing averages or maximums, which circuit is denoted POOL, allowing “Max Pool” or “Average Pool” layer computations to be carried out. A “Max Pool” operation applied to an input matrix [I] generates an output matrix [O] of size smaller than that of the input matrix, by placing the maximum of the values of a submatrix [X1] for example of the input matrix [I] into the output neuron O₀₀. An “Average Pool” operation computes the average value of all of the neurons of a submatrix of the input matrix.

Advantageously, the computing network MAC_RES especially comprises a circuit for computing an activation function, denoted ACT, that is generally used in convolutional neural networks. The activation function g(x) is a non-linear function such as a ReLu function for example.

Advantageously, the architecture illustrated in FIG. 4 especially allows a computation to be carried out with a “row-only parallelism”, delivering the same synaptic coefficients for all the computing units PEₙ of same rank of the various groups Gⱼ of computing units.

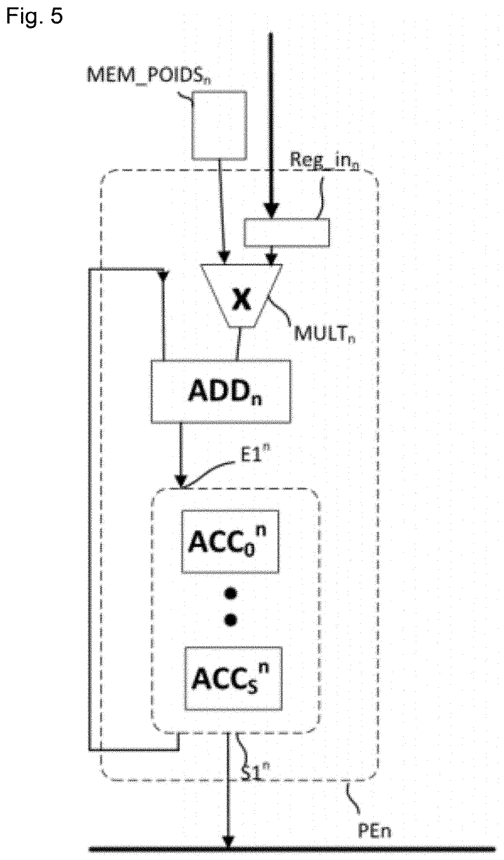

FIG. 5 illustrates an example of a functional diagram of a computing unit PEₙ belonging to a group Gⱼ of computing units of the computing network MAC_RES according to one embodiment of the invention.

Each computing unit PEₙ of rank n=0 to 127 belonging to a group Gⱼ of computing units comprises an input register, denoted Reg_inₙ, for storing an input datum used in the computation of a neuron of the layer in course; a multiplier circuit, denoted MULTₙ, with two inputs and one output; an adder circuit, denoted ADDₙ, having a first input connected to the output of the multiplier circuit MULTₙ and being configured to carry out summing operations on partial results of computation of a weighted sum; at least one accumulator, denoted ACCᵢⁿ, for storing the partial or final results of computation of the weighted sum computed by the computing unit PEₙ of rank n. The set of accumulators is connected to the second output of the adder ADDₙ, with a view to adding, in each cycle, the obtained multiplication result to the partial weighted sum obtained beforehand.

In the described embodiment, which is suitable for a computation with a “row and column spatial parallelism”, when the number of output channels is higher than the number of computing units PEₙ, each computing unit PEₙ comprises a plurality of accumulators ACCᵢⁿ. The set of accumulators belonging to the same computing unit comprises a write input, denoted E1ⁿ, which is selectable from the inputs of each accumulator of the set, and a read output, denoted S1ⁿ, which is selectable from the outputs of each accumulators of the set. This functionality as regards selection of the write input and read output of a stack of accumulator registers may be achieved via commands for activating loading of the registers in write mode and via an arrangement of multiplexers as regards the outputs (not shown in FIG. 5).

During a data-propagating phase, the multiplier MULTₙ multiplies an input datum x_{i,j} by the appropriate synaptic coefficient wᵢⱼ, according to one of the convolution-computing modalities detailed above. Specifically, to compute the output neuron O₀₀ (equal to the convolution [X1]⊗[W]) the multiplier carries out the multiplication x₀₀·w₀₀ and stores the partial result in one of the accumulators of the computing unit, then computes the second term of the weighted sum, x₁₀·w₁₀, which is added to the stored first term x₀₀·w₀₀, and so on until the entirety of the weighted sum, which is equal to the output neuron O₀₀=[X1]⊗[W], has been computed.

It will be recalled that: O_{0,0}=x₀₀·w₀₀+x₁₀·w₁₀+x₂₀·w₂₀+x₀₁·w₀₁+x₁₁·w₁₁+x₂₁·w₂₁+x₀₂·w₀₂+x₁₂·w₁₂+x₂₂·w₂₂. Without departing from the scope of the invention, other implementations are envisionable as regards production of a computing unit PEₙ.

In the preceding section an example of a physical implementation of the computer according to the invention that is preferable when carrying out computation with a “row and column spatial parallelism” was described. In the following section, the various embodiments achievable with the computer according to the invention, namely the first mode of computation with “row parallelism” and the second mode of computation with “row and column spatial parallelism” will be described. In the following section, the operation of the computing network MAC_RES as regards the computation of multiple types of convolution i.e. convolution operations with multiple filter sizes and multiple strides, will be described.

We will start with convolution with a filter of 3×3 size and a stride equal to 1 in a computing network MAC_RES composed of 3×3 groups of computing units. To simplify comprehension of the operating mode we will first of all limit discussion to a structure with a single input channel and a single output channel. Since there is only one output channel, each group G₁ to G₉ of computing units comprises a single computing unit PE₀. Thus, there is a single weight memory MEM_POIDS₀, which is connected to all of the computing units and which contains the synaptic coefficients wᵢⱼ of [W]_{p,q′}^{k} with p=0 and q=0 (since the explanation is limited to a single input channel and a single output channel).

This arrangement is considered purely for the purposes of explanation-practical cases with a plurality of input channels and a plurality of output channels apply the same computing principle as described below, with a specific distribution of the synaptic coefficients wᵢⱼ of the filters [W]_{p,q′}^{k} in the weight memories MEM_POIDSₙ.

Specifically, for any input channel of rank p, all of the weight matrices [W]_{p,q′}^{k} related to the output channel of rank q are stored in the weight memories MEM_POIDSₙ of rank n=q. All of the computing units PEₙ of rank n=q belonging to the various groups Gⱼ, carry out all of the multiplication and addition operations, to obtain the output matrix [O]_{q} output on the output channel of rank q in an inference phase or a propagation phase.

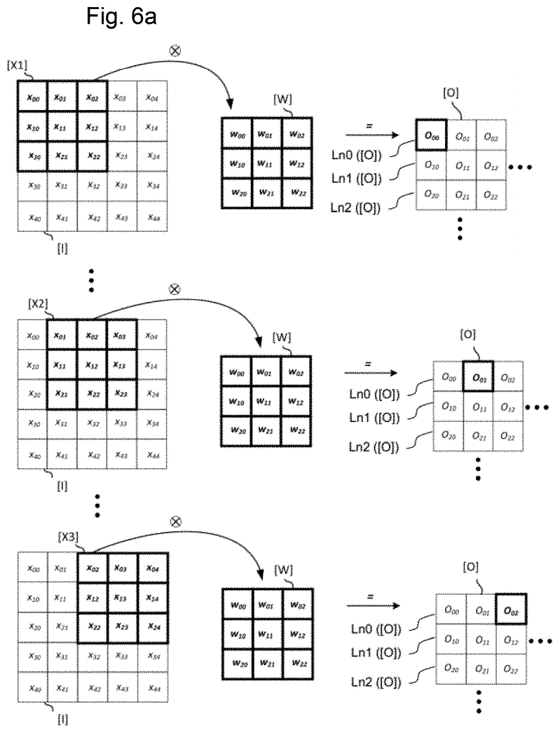

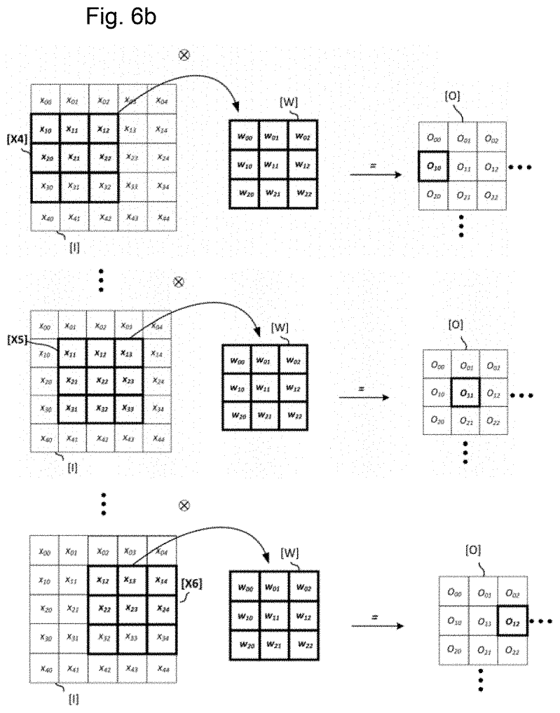

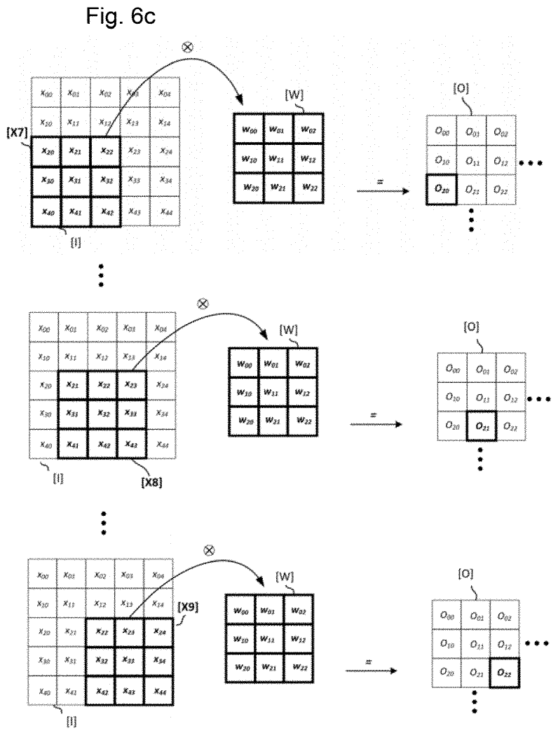

FIGS. 6a, 6b and 6c show convolution operations that may be carried out with a spatial parallelism by the computing network according to one embodiment, to obtain one portion of the output matrix [O] output on an output channel from an input matrix input on an input channel, during a 3×3s1 convolution.

In FIGS. 6a, 6b and 6c, only that portion of an input matrix [I] composed of submatrices (or neuron receptive fields) which overlaps with the submatrix [X1] has been shown. This results in the use of at the least one input datum x_{i,j} common to the submatrix [X1]. Thus it, it is possible for various groups Gⱼ of computing units, which are composed of a single computing unit PE₀ in this illustrative example, to carry out computations using these common input data.

FIGS. 6a-6c illustrate the convolution operations carried out to obtain the portion of the output matrix [O]. Said portion (or submatrix) is obtained following operations of 3×3s1 convolution with the filter matrix [W], these operations being carried out in parallel by the computing network MAC_RES.

Thus, it is possible to introduce a 3×3s1 spatial parallelism into the computation of the convolution of a portion of 5×5 size of the input matrix [I], to obtain a portion of 3×3 size of the output matrix [O].

The filter matrix [W] of coefficients w_{i,j} is composed of three column vectors of size 3, denoted Col0([W]), Col1([W]) and Col2([W]), respectively. Col0([W])=(w₀₀ w₁₀ w₂₀); Col1([W])=(w₀₁ w₁₁ w₂₁); and Col2([W])=(w₀₂ w₁₂ w₂₂).

The row vector equal to the transpose of a column vector Col([W]) is denoted Col([W])^{T}.

The submatrix [X1] is composed of three column vectors of size 3, denoted Col0([X1]), Col1([X1]) and Col2([X1]), respectively. Col0([X1])=(x₀₀ x₁₀ x₂₀); Col1([X1])=(x₀₁ x₁₁ x₂₁); and Col2([X1])=(x₀₂ x₁₂ x₂₂).

The output result O_{0,0} of the output matrix [O] is obtained via the following computation: O_{0,0}=[X1]⊗[W]

O_{0,0}=Col0([W])^{T}·Col0([X1])+Col1([W])^{T}·Col1([X1])+Col2([W])^{T}·Col2([X1])

O_{0,0}=(x₀₀·w₀₀+x₁₀·w₁₀+x₂₀·w₂₀)+(x₀₁·w₀₁+x₁₁·w₁₁+x₂₁·w₂₁)+(x₀₂·w₀₂+x₁₂·w₁₂+x₂₂·w₂₂)

The submatrix [X2] is composed of three column vectors of size 3, denoted Col0([X2]), Col1([X2]) and Col2([X2]), respectively. Col0([X2])=(x₀₁ x₁₁ x₂₁); Col1([X2])=(x₀₂ x₁₂ x₂₂); and Col2([X2])=(x₀₃ x₁₃ x₂₃).

The output result O_{0,1} of the output matrix [O] is obtained via the following computation: O_{0,1}=[X2]⊗[W]

O_{0,1}=Col0([W])^{T}·Col0([X2])+Col1([W])^{T}·Col1([X2])+Col2([W])^{T}·Col2([X2])

O_{0,1}=(x₀₁·w₀₀+x₁₁·w₁₀+x₂₁·w₂₀)+(x₀₂·w₀₁+x₁₂·w₁₁+x₂₂·w₂₁)+(x₀₃·w₀₂+x₁₃·w₁₂+x₂₃·w₂₂)

The submatrix [X3] is composed of three column vectors of size 3, denoted Col0([X3]), Col1([X3]) and Col2([X3]), respectively. Col0([X3])=(x₀₂ x₁₂ x₂₂); Col1 ([X3])=(x₀₃ x₁₃ x₂₃); Col2([X3])=(x₀₄ x₁₄ x₂₄).

The output result O_{0,2} of the output matrix [O] is obtained via the following computation: O₀₂=[X3]⊗[W]

O₀₂=Col0([W])^{T}·Col0([X3])+Col1([W])^{T}·Col1([X3])+Col2([W])^{T}·Col2([X3])

O₀₂=(x₀₂·w₀₀+x₁₂·w₁₀+x₂₂·w₂₀)+(x₀₃·w₀₁+x₁₃·w₁₁+x₂₃·w₂₁)+(x₀₄·w₀₂+x₁₄·w₁₂+x₂₄·w₂₂).

The submatrix [X4] is composed of three column vectors of size 3, denoted Col0([X4]), Col1([X4]) and Col2([X4]), respectively. Col0([X4])=(x₁₀ x₂₀ x₃₀); Col1([X4])=(x₁₁ x₂₁ x₃₁): and Col2([X4])=(x₁₂ x₂₂ x₃₂).

The output result O₁₀ of the output matrix [O] is obtained via the following computation: O₁₀=[X4]⊗[W]

O₁₀=Col0([W])^{T}·Col0([X4])+Col1([W])^{T}·Col1([X4])+Col2([W])^{T}·Col2([X4])

O₁₀=(x₁₀·w₀₀+x₂₀·w₁₀+x₃₀·w₂₀)+(x₁₁·w₀₁+x₂₁·w₁₁+x₃₁·w₂₁)+(x₁₂·w₀₂+x₂₂·w₁₂+x₃₂·w₂₂)

The submatrix [X5] is composed of three column vectors of size 3, denoted Col0([X5]), Col1([X5]) and Col2([X5]), respectively. Col0([X5])=(x₁₁ x₂₁ x₃₁); Col1 ([X5])=(x₁₂ x₂₂ x₃₂); and Col2([X5])=(x₁₃ x₂₃ x₃₃).

The output result O₁₁ of the output matrix [O] is obtained via the following computation: O₁₁=[X5]⊗[W]

O₁₁=Col0([W])^{T}·Col0([X5])+Col1([W])^{T}·Col1([X5])+Col2([W])^{T}·Col2([X5])

O₁₁=(x₁₁·w₀₀+x₂₁·w₁₀+x₃₁·w₂₀)+(x₁₂·w₀₁+x₂₂·w₁₁+x₃₂·w₂₁)+(x₁₃·w₀₂+x₂₃·w₁₂+x₃₃·w₂₂).

The submatrix [X6] is composed of three column vectors of size 3, denoted Col0([X6]), Col1([X6]) and Col2([X6]), respectively. Col0([X6])=(x₁₂ x₂₂ x₃₂); Col1 ([X6])=(x₁₃ x₂₃ x₃₃); and Col2([X6])=(x₁₄ x₂₄ x₃₄).

The output result O₁₂ of the output matrix [O] is obtained via the following computation: O₁₂=[X6]⊗[W]

O₁₂=Col0([W])^{T}·Col0([X6])+Col1([W])^{T}·Col1([X6])+Col2([W])^{T}·Col2([X6])

O₁₂=(x₁₂·w₀₀+x₂₂·w₁₀+x₃₂·w₂₀)+(x₁₃·w₀₁+x₂₃·w₁₁+x₃₃·w₂₁)+(x₁₄·w₀₂+x₂₄·w₁₂+x₃₄·w₂₂).

The submatrix [X7] is composed of three column vectors of size 3, denoted Col0([X7]), Col1([X7]) and Col2([X7]), respectively. Col0([X7])=(x₂₀ x₃₀ x₄₀); Col1([X7])=(x₂₁ x₃₁ x₄₁); and Col2([X7])=(x₂₂ x₃₂ x₄₂).

The output result O₂₀ of the output matrix [O] is obtained via the following computation: O₂₀=[X7]⊗[W]

O₂₀=Col0([W])^{T}·Col0([X7])+Col1([W])^{T}·Col1([X7])+Col2([W])^{T}·Col2([X7]).

O₂₀=(x₂₀·w₀₀+x₃₀·w₁₀+x₄₀·w₂₀)+(x₂₁·w₀₁+x₃₁·w₁₁+x₄₁·w₂₁)+(x₂₂·w₀₂+x₃₂·w₁₂+x₄₂·w₂₂).

The submatrix [X8] is composed of three column vectors of size 3, denoted Col0([X8]), Col1([X8]) and Col2([X8]), respectively. Col0([X8])=(x₂₁ x₃₁ x₄₁); Col1([X8])=(x₂₂ x₃₂ x₄₂); and Col2([X8])=(x₂₃ x₃₃ x₄₃).

The output result O₂₁ of the output matrix [O] is obtained via the following computation: O₂₁=[X8]⊗[W]

O₂₁=Col0([W])^{T}·Col0([X8])+Col1([W])^{T}·Col1([X8])+Col2([W])^{T}·Col2([X8])

O₂₁=(x₂₁·w₀₀+x₃₁·w₁₀+x₄₁·w₂₀)+(x₂₂·w₀₁+x₃₂·w₁₁+x₄₂·w₂₁)+(x₂₃·w₀₂+x₃₃·w₁₂+x₄₃·w₂₂).

The submatrix [X9] is composed of three column vectors of size 3, denoted Col0([X9]), Col1([X9]) and Col2([X9]), respectively. Col0([X9])=(x₂₂ x₃₂ x₄₂); Col1([X9])=(x₂₃ x₃₃ x₄₃); and Col2([X9])=(x₂₄ x₃₄ x₄₄).

The output result O₂₂ of the output matrix [O] is obtained via the following computation: O₂₂=[X9]⊗[W]

O₂₂=Col0([W])^{T}·Col0([X9])+Col1([W])^{T}·Col1([X9])+Col2([W])^{T}·Col2([X9])

O₂₂=(x₂₂·w₀₀+x₃₂·w₁₀+x₄₂·w₂₀)+(x₂₃·w₀₁+x₃₃·w₁₁+x₄₃·w₂₁)+(x₂₄·w₀₂+x₃₄·w₁₂+x₄₄·w₂₂).

Thus, a plurality of column vectors of the input submatrices used for the computation of 9 coefficients Oᵢⱼ of the output matrix [O] are common, and hence it is possible to optimise use of the input data xᵢⱼ by the network computing units with a view to minimising the number of operations of reading and writing input data.

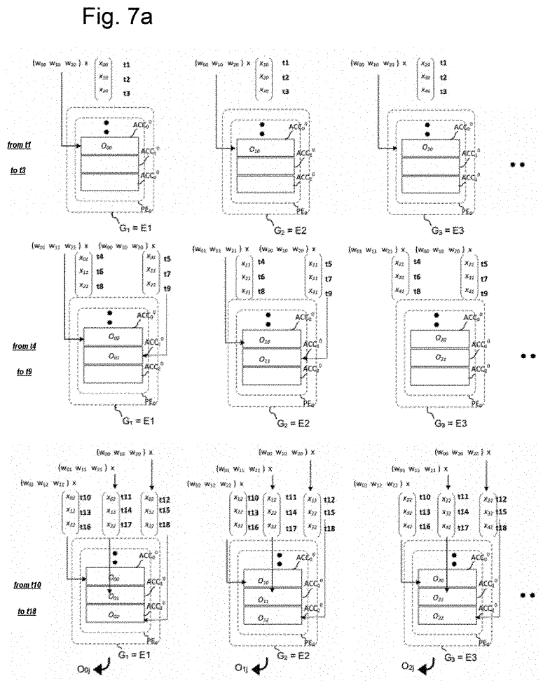

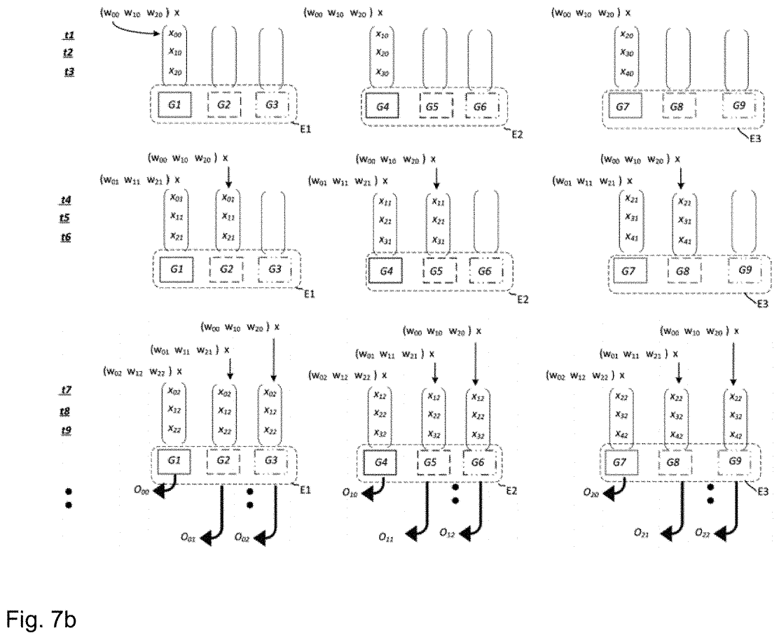

FIG. 7a illustrates operating steps of a computing network according to a first mode of computation with “a row parallelism”, for computing a 3×3s1 convolutional layer.

The order in which the data of the input matrix [I] are loaded from the external memory MEM_EXT into the buffer memory BUFF, which is of small size and integrated into the computing network, will first be described. It will be recalled that the external memory MEM_EXT (or internal memory MEM_INT) contains the data matrices of all the layers of the neural network in the process of being trained, and the input and output data matrices of a layer of neurons in the course of computation during inference. In contrast, the buffer memory BUFF is a memory of small size that contains some of the data used in the course of computation of a layer of neurons.

By way of example, the input data of an input matrix [I] in the external memory MEM_EXT are arranged such that all the channels, for a given pixel of the input image, are placed sequentially. For example, if the input matrix is an image matrix of N×N size composed of 3 input channels, one for each of the colours red, green and blue (RGB), the input data x_{i,j} are arranged in the following way:

$${X}_{00 R} {X}_{00 G} {X}_{00 B} , {X}_{01 R} {X}_{01 G} {X}_{01 B} , {X}_{02 R} {X}_{02 G} {X}_{02 B} , … , {X}_{0 ( N - 1 ) R} {X}_{0 ( N - 1 ) G} {X}_{0 ( N - 1 ) B} \\ {X}_{10 R} {X}_{10 G} {X}_{10 B} , {X}_{11 R} {X}_{11 G} {X}_{11 B} , {X}_{12 R} {X}_{12 G} {X}_{12 B} , … , {X}_{1 ( N - 1 ) R} {X}_{1 ( N - 1 ) G} {X}_{1 ( N - 1 ) B} \\ {X}_{20 R} {X}_{20 G} {X}_{20 B} , {X}_{21 R} {X}_{21 G} {X}_{21 B} , {X}_{22 R} {X}_{22 G} {X}_{22 B} , … , {X}_{2 ( N - 1 ) R} {X}_{2 ( N - 1 ) G} {X}_{2 ( N - 1 ) B} \\ … \\ {X}_{( N - 1 ) 0 R} {X}_{( N - 1 ) 0 G} {X}_{( N - 1 ) 0 B} , {X}_{( N - 1 ) 1 R} {X}_{( N - 1 ) 1 G} {X}_{( N - 1 ) 1 B} , … , {X}_{( N - 1 ) ( N - 1 ) R} {X}_{( N - 1 ) ( N - 1 ) G} {X}_{( N - 1 ) ( N - 1 ) B}$$

It will be recalled that in the case of FIG. 7a consideration has been limited to a single input channel for the sake of simplicity.

During the computation of a convolutional layer, and with a view to minimising the exchange of data between the memories and the computer network, the input data are loaded by subset into the buffer memory BUFF of small size. By way of example, the buffer memory BUFF is organised into two columns each containing from 5 to 19 lines with data coded on 16 bits and packets of data coded on 64 bits. Alternatively, it is possible to organise the buffer memory BUFF with data coded on 8 bits or 4 bits depending on the specifications and the technical constraints of the neural-network design. Likewise, the number of rows of the buffer memory BUFF may be tailored to the specifications of the system.

To carry out a 3×3s1 convolution computation with “a row parallelism” as regards the rows of the output matrix, and according to the first mode of computation, the read-out of the data x_{i,j} and the execution of the computation are organised in the following way:

The group G1 carries out all of the computations to obtain the first row of the output matrix, which is denoted Ln0([O]). The group G2 carries out all of the computations to obtain the second row of the output matrix, which is denoted Ln1([O]). The group G3 carries out all of the computations to obtain the third row of the output matrix, which is denoted Ln2([O]) and so on. Thus, with nine groups of computing units it is possible to parallelise the computation of the first nine rows of the output matrix [0].

Once the group G1 has completed the computation of the output neurons O₀ⱼ of the first row Ln0([O]), it starts neuron computations to obtain the results O₉ⱼ of the row Ln9([O]) of the output matrix, then those of the row Ln18([O]) and so on. More generally, the group Gⱼ of rank j avec j=1 to M computes the output data of all of the i^{th} rows of the output matrix [O] such that i modulo M=j−1.

During initiation of the computation of a convolutional layer, the buffer memory BUFF receives a packet of input data xᵢⱼ from the external memory MEM_EXT or from the internal memory MEM_INT. The storage capacity of the buffer memory allows the input data of the portion composed of the submatrices [X1] to [X9] having data common with the initial submatrix [X1] to be loaded. This allows a spatial parallelism to be introduced into the computation of the 9 first output data of the output matrix [O], without loading data from the external global memory MEM_EXT each time.

The buffer memory BUFF has 9 read ports, each port being connected to one group Gⱼ via the input register Reg_in of the computing unit PEᵢ of the group. In the case where there are a plurality of output channels, the computing units PEᵢ of a given group Gⱼ receive the same input data xᵢⱼ but receive different synaptic coefficients.

In the embodiment compatible with computation with “a row parallelism”, when the number of output channels is higher than the number of computing units PEₙ or when the convolution is of order higher than 1, each computing unit PEₙ comprises a plurality of accumulators ACCᵢⁿ.

Between t1 and t3, the first group G1 receives as input the first column of size 3 of the submatrix [X1]. The group G1 carries out, in three consecutive cycles, the following computation of the partial result Col0([W])^{T}·Col0([X1]) of the equation for computing O_{0,0}

O_{0,0}=Col0([W])^{T}·Col0([X1])+Col1([W])^{T}·Col1([X1])+Col2([W])^{T}·Col2([X1])

O_{0,0}=(x₀₀·w₀₀+x₁₀·w₁₀+x₂₀·w₂₀)+(x₀₁·w₀₁+x₁₁·w₁₁+x₂₁·w₂₁)+(x₀₂·w₀₂+x₁₂·w₁₂+x₂₂·w₂₂).

More precisely, the computing unit PE₀ of the group G1 computes x₀₀·w₀₀ at t1 and stores the partial result in an accumulator ACC₀⁰. At t2 the same computing unit PE₀ computes x₁₀·w₁₀ and adds the result to x₀₀·w₀₀ stored in the accumulator ACC₀⁰. At t3 the same computing unit PE₀ computes x₂₀·w₂₀ and adds the multiplication result to the partial result stored in the accumulator ACC₀⁰.

Simultaneously, between t1 and t3, the second group G2 receives as input the first column of size 3 of the submatrix [X4]. The group G2 carries out, in three consecutive cycles, the following computation of the partial result Col0([W])^{T}·Col0([X4]) of the equation for computing O_{1,0}

O_{1,0}=Col0([W])^{T}·Col0([X4])+Col1([W])^{T}·Col1([X4])+Col2([W])^{T}·Col2([X4])

O₁₀=(x₁₀·w₀₀+x₂₀·w₁₀+x₃₀·w₂₀)+(x₁₁·w₀₁+x₂₁·w₁₁+x₃₁·w₂₁)+(x₁₂·w₀₂+x₂₂·w₁₂+x₃₂·w₂₂)

More precisely, the computing unit PE₀ of the group G2 computes x₁₀·w₀₀ at t1 and stores the partial result in its accumulator ACC₀⁰. At t2 the same computing unit PE₀ computes x₂₀·w₁₀ and adds the result to x₁₀·w₀₀ stored in the accumulator ACC₀⁰. At t3 the same computing unit PE₀ computes x₃₀·w₂₀ and adds the multiplication result to the partial result stored in the accumulator ACC₀⁰.

Simultaneously, between t1 and t3, the third group G3 receives as input the first column of size 3 of the submatrix [X7]. The group G3 carries out, in three consecutive cycles, the following computation of the partial result Col0([W])^{T}·Col0([X7]) of the equation for computing O_{2,0}

O₂₀=Col0([W])^{T}·Col0([X7])+Col1([W])^{T}·Col1([X7])+Col2([W])^{T}·Col2([X7])

O₂₀=(x₂₀·w₀₀+x₃₀·w₁₀+x₄₀·w₂₀)+(x₂₁·w₀₁+x₃₁·w₁₁+x₄₁·w₂₁)+(x₂₂·w₀₂+x₃₂·w₁₂+x₄₂·w₂₂).

More precisely, the computing unit PE₀ of the group G3 computes x₂₀·w₀₀ at t1 and stores the partial result in its accumulator ACC₀⁰. At t2 the same computing unit PE₀ computes x₃₀·w₁₀ and adds the result to x₂₀·w₀₀ stored in the accumulator ACC₀⁰. At t3 the same computing unit PE₀ computes x₄₀·w₂₀ and adds the multiplication result to the partial result stored in the accumulator ACC₀⁰.

The column Col0([X4])=(x₁₀ x₂₀ x₃₀) transmitted to the group G2 corresponds to the column obtained via a shift of one additional row of the column Col0([X1])=(x₀₀ x₁₀ x₂₀) transferred to the group G1. Likewise, the column Col0([X7])=(x₂₀ x₃₀ x₄₀) transmitted to the group G3 corresponds to the column obtained via a shift of one additional row of the column Col0([X4])=(x₁₀ x₂₀ x₃₀) transferred to the group G2.

More generally, if the first group G1 receives the column of input data (x_{i,j} x_{(i+1),j} x_{(i+2),j}), the group of rank k receives the column of input data (x_{(i+sk),j} x_{(i+sk+1),j} x_{(i+sk+2),j}) with s the stride of the convolution carried out.

Between t4 and t9, the first group G1 receives the column vector (x₀₁ x₁₁ x₂₁) corresponding to the second column of the submatrix [X1] (denoted Col1([X1])) but also to the first column of the submatrix [X2] (denoted Col0([X2])). Thus, the group of computing units of rank 1 G1 carries out, in six consecutive cycles, the following computation: at t4 the input register Reg_in of the computing unit PE₀ of the group G1 stores the input datum x₀₁. The multiplier MULT computes x₀₁·w₀₁ and adds the obtained result to the content of the accumulator ACC₀⁰ dedicated to the output datum O_{0,0}. At t5, the computing unit of the group G1 keeps the input data x₀₁ in its input register to compute the partial result x₀₁·w₀₀, which will be stored in the accumulator ACC₁⁰ by way of first term of the weighted sum of the output result O_{0,1}. At t6, the input datum x₁₁ is loaded in order to continue the computation of O_{0,0} by computing x₁₁·w₁₁ and adding it to the content of the accumulator ACC₀⁰. Next, at t7, the computing unit PE₀ of the group G1 keeps x₁₁ to compute x₁₁·w₁₀ and adds it to the content of the accumulator ACC₁⁰ dedicated to the storage of the partial results of the output result O_{0,1}.

Simultaneously, the same process is undergone with the group G2 dedicated to the computation of the second row of the output matrix [O]. Thus, between t4 and t9, the second group G2 receives the column vector (x₁₁ x₂₁ x₃₁) corresponding to the second column of the submatrix [X4] (denoted Col1 ([X4])) but also to the first column of the submatrix [X5] (denoted Col0([X5])). Thus, the group of computing units of rank 2 G2 carries out, in six consecutive cycles, the following computation: at t4 the input register Reg_in of the computing unit PE₀ of the group G2 stores the input datum x₁₁. The multiplier MULT computes x₁₁·w₀₁ and adds the obtained result to the content of the accumulator ACC₀⁰ dedicated to the output datum O_{1,0}. At t5, the computing unit of the group G2 keeps the input data x₁₁ in its input register to compute the partial result x₁₁·w₀₀, which will be stored in the accumulator ACC₁⁰ by way of first term of the weighted sum of the output result O_{1,1}. At t6, the input datum x₂₁ is loaded in order to continue the computation of O_{1,0} by computing x₂₁·w₁₁ and adding it to the content of the accumulator ACC₀⁰. Next, at t7, the computing unit PE₀ of the group G2 keeps x₂₁ to compute x₂₁·w₁₀ and to add it to the content of the accumulator ACC₁⁰ dedicated to the storage of the partial results of the output result O_{1,1}.

Simultaneously, the same process is undergone with the third group G3, which will scan the column of input data (x₂₁ x₃₁ x₄₁) corresponding to the second column of the submatrix [X7] (denoted Col1 ([X7])) but also to the first column of the submatrix [X8] (denoted Col0([X8])). The group of computing units G3 of rank 3 computes and stores the partial results of O₂₀ in the accumulator ACC₀⁰ and reuses the common input data to compute partial results of O₂₁, which are stored in the accumulator ACC₁⁰ of the same computing unit.

Between t10 and t18, the first group G1 receives the column vector (x₀₂ x₁₂ x₂₂) corresponding to the third and last column of the submatrix [X1] (denoted Col2([X1])) but also to the second column of the submatrix [X2] (denoted Col1 ([X2])) and to the first column of the submatrix [X3] (denoted Col0([X3])). Thus, the group of computing units of rank 1 G1 carries out, in 9 consecutive cycles, some of the computation of the output results O₀₀ stored in ACC₀⁰, some of the computation of the output results O₀₁ stored in ACC₁⁰ and some of the computation of the output results O₀₂ stored in ACC₂⁰, according to the computing principle described above.

Simultaneously, the same process is undergone with the second group G2, which will scan the column of input data (x₁₂ x₂₂ x₃₂) corresponding to the last column of the submatrix [X4] (denoted Col2([X4])) but also to the second column of the submatrix [X5] (denoted Col1 ([X5])) and to the first column of the submatrix [X6](denoted Col0([X6])). Thus the group of computing units of rank 2 G2 carries out, in 9 consecutive cycles, the computation of the output result O₁₀ stored in ACC₀⁰, the computation of the output result O₁₁ stored in ACC₁⁰, and the computation of the output result O₁₂ stored in ACC₂⁰, according to the computing principle described above.

Simultaneously, the same process is undergone with the third group G3, which will scan the column of input data (x₂₂ x₃₂ x₄₂) corresponding to the last column of the submatrix [X7] (denoted Col2([X7])) but also to the second column of the submatrix [X8] (denoted Col1 ([X8])) and to the first column of the submatrix [X9] (denoted Col0([X9])). Thus the group of computing units of rank 3 G3 carries out, in 9 consecutive cycles, the computation of the output result O₂₀ stored in ACC₀⁰, the computation of the output result O₂₁ stored in ACC₁⁰, and the computation of the output result O₂₂ stored in ACC₂⁰, according to the computing principle described above.

When the group of rank 1 G1 has completed the computation of the output result O₀₀ at t18, it starts the computation of O₀₃ at t19 such that the partial results of O₀₃ are stored in ACC₀⁰.

More generally, in a group Gⱼ of rank j=1 to M the computing unit PE₀ computes all of the output results of each row of the output matrix [O] of rank i such that i modulo M=(j−1).

More generally, to carry out a 3×3s1 convolution with 9 groups of computing units, the input data are read from the buffer memory BUFF in the following way: the columns read via each bus are of size equal to those of the weight matrix [W] (three in this case).

On reaching a steady state (from t10) every nine cycles, a shift of one column is realised via a data bus (incrementation of a column of size 3); on each passage from one bus to the next (from BUS1 to BUS2 for example) a shift of a number of rows equal to the stride is achieved.

In the case where the output matrix [O] is obtained via a plurality of input channels, the input data x_{00R} x_{00G} x_{00B} corresponding to a given pixel of the input image are read by the computing unit PE₀ in series before computations are carried out using the input data of the following pixel of the column being read.

In the case where there are a plurality of output matrices of rank q=0 to Q on a plurality of output channels of same rank, the computing units PEₙ of rank n=q belonging to the various groups Gⱼ carry out all of the multiplication and addition operations to obtain the output matrix [O]_{q} output on the output channel of rank q. By way of example, the computing unit PE_{q} of rank q of group G1 carries out the computation of the output result O₀₀ of the output matrix [O]_{q}, using the same operating mode described above.

Alternatively, to carry out the phase of initialisation of the processing (phase comprised between t1 and t10 in the example described above) the computer multiplies each input datum by three different weights to compute three successive results. At the start, the first two results are irrelevant because they correspond to points located outside of the output matrix and only relevant results are retained by the computer according to the invention.

By adapting the size of the columns read from the buffer memory BUFF and the shifts between the input data received by each group, i.e. the stride of the convolution, the computation mechanism described above may be generalised to any type of convolution.

To conclude, the network MAC_RES of computing units, in association with a determined distribution and a determined read order of the input data xᵢⱼ and of the synaptic coefficients wᵢⱼ, allows any type of convolutional layers to be computed with a spatial parallelism as regards the computation of the output rows and an output channel parallelism.

In the following section, an alternative embodiment that allows complete row and column spatial parallelism to be achieved, such that the computations of the output results of a row of the matrix [O] are carried out in parallel by a plurality of groups Gⱼ of computing units, will be described.

FIG. 7b illustrates operating steps of a computing network according to a second mode of computation with “a row and column spatial parallelism” of the invention for computing a 3×3s1 convolutional layer.

To carry out the 3×3s1 convolution computation with a row and column spatial parallelism according to the second embodiment, the read-out of the data xᵢⱼ and the execution of the computations are organised in the following way:

The group G1 carries out all of the computations of the result O₀₀, the group G2 carries out all of the computations of the result O₀₁, and the group G3 carries out all of the computations of the result O₀₂.

When the group G1 has completed the computation of the output neuron O₀₀, it starts the computations of the weighted sum to obtain the coefficient O₀₃ then O₀₆ and so on. When the group G2 has completed the computation of the output neuron O₀₁, it starts the computations of the weighted sum to obtain the coefficient O₀₄ then O₀₇ and so on. When the group G3 has completed the computation of the output neuron O₀₂, it starts the computations of the weighted sum to obtain the coefficient O₀₅ then O₀₈ and so on. Thus, the first set, denoted E1, composed of the groups G1, G2 and G3, computes the row of rank 0 of the output matrix [O]. Thus, the notation E1=(G1 G2 G3) is used.

When all the output data of the first row of the output matrix [O] have been computed, the group G1 starts, using the same process, the computations of the row of rank 3 of the output matrix [O], and of all the rows of rank i such that i modulo 3=0 sequentially.

The group G4 carries out all of the computations of the result O₁₀, the group G5 carries out all of the computations of the result O₁₁, and the group G6 carries out all of the computations of the result O₁₂.

When the group G4 has completed the computation of the output neuron O₁₀, it starts the computations of the weighted sum to obtain the coefficient O₁₃ then O₁₆ and so on. When the group G5 has completed the computation of the output neuron O₁₁, it starts the computations of the weighted sum to obtain the coefficient O₁₄ then O₁₇ and so on. When the group G6 has completed the computation of the output neuron O₁₂, it starts the computations of the weighted sum to obtain the coefficient O₁₅ then O₁₈ and so on. Thus, the second set, denoted E2, composed of the groups G4, G5 and G6, computes the row of rank 1 of the output matrix [O]. Thus, the notation E2=(G4 G5 G6) is used.

When all the output data of the row of rank 1 of the output matrix [O] have been computed, the group G4 starts, using the same process, the computations of the row of rank 4 of the output matrix [O], and of all the rows of rank i such that i modulo 3=1 sequentially.

The group G7 carries out all of the computations of the result O₂₀, the group G8 carries out all of the computations of the result O₂₁, and the group G9 carries out all of the computations of the result O₂₂.

When the group G7 has completed the computation of the output neuron O₂₀, it starts the computations of the weighted sum to obtain the coefficient O₂₃ then O₂₆ and so on. When the group G8 has completed the computation of the output neuron O₂₁, it starts the computations of the weighted sum to obtain the coefficient O₂₄ then O₂₇ and so on. When the group G9 has completed the computation of the output neuron O₂₂, it starts the computations of the weighted sum to obtain the coefficient O₂₅ then O₂₈ and so on. Thus, the second set, denoted E3, composed of the groups G7, G8 and G9, computes the row of rank 2 of the output matrix [O]. Thus, the notation E3=(G7 G8 G9) is used.

When all the output data of the row of rank 2 of the output matrix [O] have been computed, the group G7 starts, using the same process, the computations of the row of rank 5 of the output matrix [O], and of all the rows of rank i such that i modulo 3=2 sequentially.

During initiation of the computation of a convolutional layer, the buffer memory BUFF receives a packet of input data xᵢⱼ from the external memory MEM_EXT or from the internal memory MEM_INT. The storage capacity of the buffer memory allows the coefficients of the portion composed of the submatrices [X1] to [X9] having data common with the initial submatrix [X1] to be loaded. This allows a spatial parallelism to be introduced into the computation of the 9 first output data of the output matrix [O], without loading data from the external global memory MEM_EXT each time.

The buffer memory BUFF has three read ports, each port being connected to a set of groups of computing units via one data bus; the first bus BUS1 transmits the same input data to the first set E1=(G1 G2 G3); the second bus BUS2 transmits the same input data to the second set E2=(G4 G5 G6); the third bus BUS3 transmits the same input data to the third set E3=(G7 G8 G9).

The phase between t1 and t6 corresponds to a transient state of initiation; from t7 all the groups Gⱼ of computing units carry out computations of weighted sums of various output data Oᵢⱼ.

Between t1 and t3, the set E1 of groups of computing units receives as input the first column of size 3 of the submatrix [X1]. The group G1 of the set E1 carries out, in three consecutive cycles, the following computation of the emboldened partial result of the equation for computing O_{0,0}

O_{0,0}=Col0([W])^{T}·Col0([X1])+Col1([W])^{T}·Col1([X1])+Col2([W])^{T}·Col2([X1])

O_{0,0}=(x₀₀·w₀₀+x₁₀·w₁₀+x₂₀·w₂₀)+(x₀₁·w₀₁+x₁₁·w₁₁+x₂₁·w₂₁)+(x₀₂·w₀₂+x₁₂·w₁₂+x₂₂·w₂₂).

More precisely, the computing unit PE₀ of the group G1 of the set E1 computes x₀₀·w₀₀ at t1 and stores the partial result in an accumulator ACC₀⁰. At t2 the same computing unit PE₀ computes x₁₀·w₁₀ and adds the result to x₀₀·w₀₀ stored in the accumulator ACC₀⁰. At t3 the same computing unit PE₀ computes x₂₀·w₂₀ and adds the multiplication result to the partial result stored in the accumulator ACC₀⁰.

Simultaneously, between t1 and t3, set E2 of groups of computing units receives as input the first column of size 3 of the submatrix [X4]. The group G4 of the set E2 carries out, in three consecutive cycles, the following computation of the partial result Col0([W])^{T}·Col0([X4]) of the equation for computing O_{1,0}

O₁₀=Col0([W])^{T}·Col0([X4])+Col1([W])^{T}·Col1([X4])+Col2([W])^{T}·Col2([X4])

O₁₀=(x₁₀·w₀₀+x₂₀·w₁₀+x₃₀·w₂₀)+(x₁₁·w₀₁+x₂₁·w₁₁+x₃₁·w₂₁)+(x₁₂·w₀₂+x₂₂·w₁₂+x₃₂·w₂₂)

More precisely, the computing unit PE₀ of the group G4 of the set E2 computes x₁₀·w₀₀ at t1 and stores the partial result in its accumulator ACC₀⁰. At t2 the same computing unit PE₀ computes x₂₀·w₁₀ and adds the result to x₁₀·w₀₀ stored in the accumulator ACC₀⁰. At t3 the same computing unit PE₀ computes x₃₀·w₂₀ and adds the multiplication result to the partial result stored in the accumulator ACC₀⁰.

Simultaneously, between t1 and t3, set E3 of groups of computing units receives as input the first column of size 3 of the submatrix [X7]. The group G7 of the set E3 carries out, in three consecutive cycles, the following computation of the partial result Col0([W])^{T}·Col0([X7]) of the equation for computing O_{2,0}

O₂₀=Col0([W])^{T}·Col0([X7])+Col1([W])^{T}·Col1([X7])+Col2([W])^{T}·Col2([X7])

O₂₀=(x₂₀·w₀₀+x₃₀·w₁₀+x₄₀·w₂₀)+(x₂₁·w₀₁+x₃₁·w₁₁+x₄₁·w₂₁)+(x₂₂·w₀₂+x₃₂·w₁₂+x₄₂·w₂₂).

More precisely, the computing unit PE₀ of the group G7 of the set E3 computes x₂₀·w₀₀ at t1 and stores the partial result in its accumulator ACC₀⁰. At t2 the same computing unit PE₀ computes x₃₀·w₁₀ and adds the result to x₂₀·w₀₀ stored in the accumulator ACC₀⁰. At t3 the same computing unit PE₀ computes x₄₀·w₂₀ and adds the multiplication result to the partial result stored in the accumulator ACC₀⁰.

The column Col0([X4])=(x₁₀ x₂₀ x₃₀) transmitted via the bus BUS2 to the set E2 corresponds to the column obtained via a shift of one additional row of the column Col0([X1])=(x₀₀ x₁₀ x₂₀) transferred via the bus BUS1 to the set E1. Likewise, The column Col0([X7])=(x₂₀ x₃₀ x₄₀) transmitted via the bus BUS3 to the set E3 corresponds to the column obtained via a shift of one additional row of the column Col0([X4])=(x₁₀ x₂₀ x₃₀) transferred via the bus BUS2 to the set E2.

More generally, if the bus BUS1 of rank 1 transmits to the set E1 the column of input data (x_{i,j} x_{(i+1),j} x_{(i+2),j}), the bus of rank k BUSₖ transmits the column of input data (x_{(i+sk),j} x_{(i+sk+1),j} x_{(i+sk+2),j}) with s the stride of the convolution carried out.

Between t4 and t6, the first set E1 receives the column vector (x₀₁ x₁₁ x₂₁) corresponding to the second column of the submatrix [X1] (denoted Col1([X1])) but also to the first column of the submatrix [X2] (denoted Col0([X2])). Thus, the group of computing units of rank 1 G1 carries out, in three consecutive cycles, the following computation of the partial result Col1 ([W])^{T}·Col1 ([X1]) of the equation for computing O_{0,0}:

O_{0,0}=Col0([W])^{T}·Col0([X1])+Col1([W])^{T}·Col1([X1])+Col2([W])^{T}·Col2([X1])

O_{0,0}=(x₀₀·w₀₀+x₁₀·w₁₀+x₂₀·w₂₀)+(x₀₁·w₀₁+x₁₁·w₁₁+x₂₁·w₂₁)+(x₀₂·w₀₂+x₁₂·w₁₂+x₂₂·w₂₂).

Simultaneously, the group of computing units of rank 2 G2, which receives the same column of input data, carries out, in three consecutive cycles, the computation of the partial result Col0([W])^{T}·Col0([X2]) of the equation for computing O_{0,1}:

O_{0,1}=Col0([W])^{T}·Col0([X2])+Col1([W])^{T}·Col1([X2])+Col2([W])^{T}·Col2([X2])

O_{0,1}=(x₀₁·w₀₀+x₁₁·w₁₀+x₂₁·w₂₀)+(x₀₂·w₀₁+x₁₂·w₁₁+x₂₂·w₂₁)+(x₀₃·w₀₂+x₁₃·w₁₂+x₂₃·w₂₂)

Simultaneously, the same process is undergone with the second set E2, which will scan the column of input data (x₁₁ x₂₁ x₃₁) corresponding to the second column of the submatrix [X4] (denoted Col1 ([X4])) but also to the first column of the submatrix [X5] (denoted Col0([X5])). The group G4 of computing units of rank 4 computes the term Col1 ([W])^{T}·Col1 ([X4]) of O₁₀ and the group G5 of computing units of rank 5 computes the term Col0([W])^{T}·Col0([X5]) of O₁₁.

Simultaneously, the same process is undergone with the third set E3, which will scan the column of input data (x₂₁ x₃₁ x₄₁) corresponding to the second column of the submatrix [X7] (denoted Col1 ([X7])) but also to the first column of the submatrix [X8] (denoted Col0([X8])). The group G7 of computing units of rank 7 computes the term Col1 ([W])^{T}·Col1 ([X7]) of O₂₀ and the group G8 of computing units of rank 8 computes the term Col0([W])^{T}·Col0([X8]) of O₂₁.

Between t7 and t9, the first set E1 receives the column vector (x₀₂ x₁₂ x₂₂) corresponding to the third and last column of the submatrix [X1] (denoted Col2([X1])) but also to the second column of the submatrix [X2] (denoted Col1 ([X2])) and to the first column of the submatrix [X3] (denoted Col0([X3])). Thus, the group of computing units of rank 1 G1 carries out, in 3 consecutive cycles, the computation of the last partial result Col2([W])^{T}·Col2([X1]) of the equation for computing O_{0,0}:

O_{0,0}=Col0([W])^{T}·Col0([X1])+Col1([W])^{T}·Col1([X1])+Col2([W])^{T}·Col2([X1])

O_{0,0}=(x₀₀·w₀₀+x₁₀·w₁₀+x₂₀·w₂₀)+(x₀₁·w₀₁+x₁₁·w₁₁+x₂₁·w₂₁)+(x₀₂·w₀₂+x₁₂·w₁₂+x₂₂·w₂₂.

Simultaneously, the group of computing units of rank 2 G2, which receives the same column of input data, carries out, in three consecutive cycles, the computation of the partial result Col1 ([W])^{T}·Col1 ([X2]) of the equation for computing O_{0,1}:

O_{0,1}=Col0([W])^{T}·Col0([X2])+Col1([W])^{T}·Col1([X2])+Col2([W])^{T}·Col2([X2])

O_{0,1}=(x₀₁·w₀₀+x₁₁·w₁₀+x₂₁·w₂₀)+(x₀₂·w₀₁+x₁₂·w₁₁+x₂₂·w₂₁)+(x₀₃·w₀₂+x₁₃·w₁₂+x₂₃·w₂₂).

Simultaneously, the group of computing units of rank 3 G3, which receives the same column of input data, carries out, in three successive consecutive cycles, the computation of the first partial result of the equation for computing O_{0,2}, which is equal to Col0([W])^{T}·Col0([X3]).

Simultaneously, the same process is undergone with the second set E2, which will scan the column of input data (x₁₂ x₂₂ x₃₂) corresponding to the last column of the submatrix [X4] (denoted Col2([X4])) but also to the second column of the submatrix [X5] (denoted Col1 ([X5])) and to the first column of the submatrix [X6] (denoted Col0([X6])). The group G4 of computing units of rank 4 computes the term Col2([W])^{T}·Col2([X4]) of O₁₀, the group G5 of computing units of rank 5 computes the term Col1([W])^{T}·Col1([X5]) de O₁₁, and the group G6 of computing units of rank 6 computes the term Col0([W])^{T}·Col0([X6]) of O₁₂.

Simultaneously, the same process is undergone with the third set E3, which will scan the column of input data (x₂₂ x₃₂ x₄₂) corresponding to the last column of the submatrix [X7] (denoted Col2([X7])) but also to the second column of the submatrix [X8] (denoted Col1 ([X8])) and to the first column of the submatrix [X9] (denoted Col0([X9])). The group G7 of computing units of rank 7 computes the final term Col2([W])^{T}·Col2([X7]) of O₂₀, the group G9 of computing units of rank 9 computes the term Col1 ([W])^{T}·Col1 ([X9]) de O₂₁, and the group G9 of computing units of rank 9 computes the term Col0([W])^{T}·Col0([X6]) of O₂₂.

Thus, the computing network MAC_RES enters into the steady computation state in which all the groups carry out computations in parallel of various neurons of the output matrix [0].

More generally, to carry out a 3×3s1 convolution with 3×3 groups of computing units (3 sets E each containing 3 groups G), the input data are read from the buffer memory BUFF in the following way: the columns read via each bus have a size equal to those of the weight matrix [W] (three in this case); each three cycles, a shift of one column is carried out via a data bus (incrementation of a column of size 3); on each passage from one bus to the next (from BUS1 to BUS2 for example) a shift of a number of rows equal to the stride is achieved.

From t10, the group G1 of computing units starts the computations of O₀₃ successively using the columns (x₀₃ x₁₃ x₂₃), (x₀₄ x₁₄ x₂₄), (x₀₅ x₁₅ x₂₅). From t19, the group G1 of computing units starts the computations of O₀₆ successively using the columns (x₀₆ x₁₆ x₂₆), (x₀₇ x₁₇ x₂₇), (x₀₈ x₁₈ x₁₂) and so on.

In the case where the output matrix [O] is obtained via a plurality of input channels, the input data x_{00R} x_{00G} x_{00B} corresponding to a given pixel of the input image are read by the computing unit PE₀ in series before computations are carried out using the input data of the following pixel of the column being read.

In the case where there are a plurality of output matrices of rank q=0 to Q on a plurality of output channels of same rank, the computing units PEₙ of rank n=q belonging to the various groups Gⱼ carry out all of the multiplication and addition operations to obtain the output matrix [O]_{q} output on the output channel of rank q. By way of example, the computing unit PE_{q} of rank q of group G1 carries out the computation of the output result O₀₀ of the output matrix [O]_{q}, using the same operating mode described above.

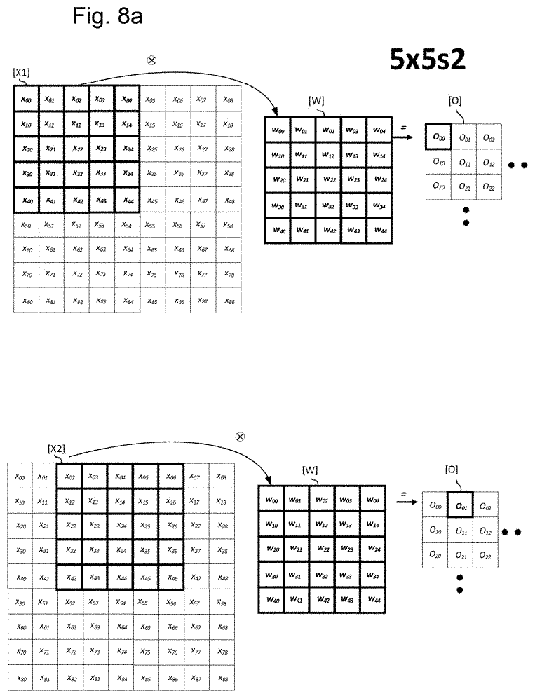

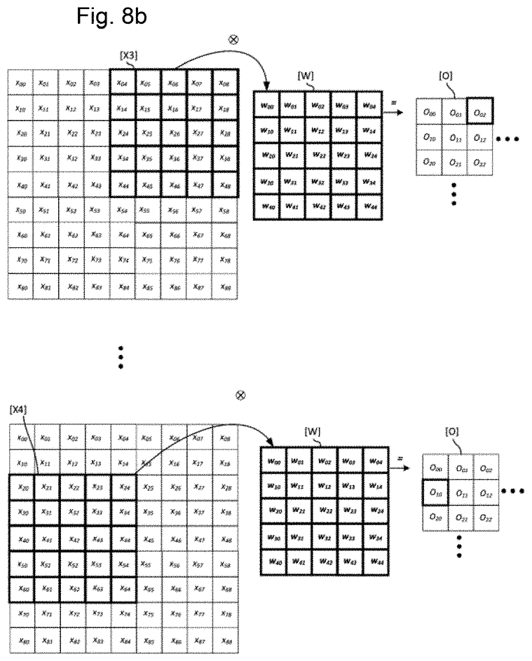

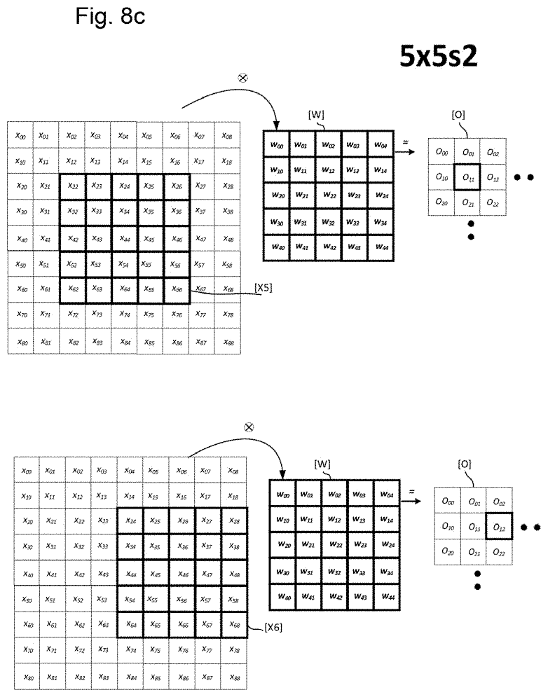

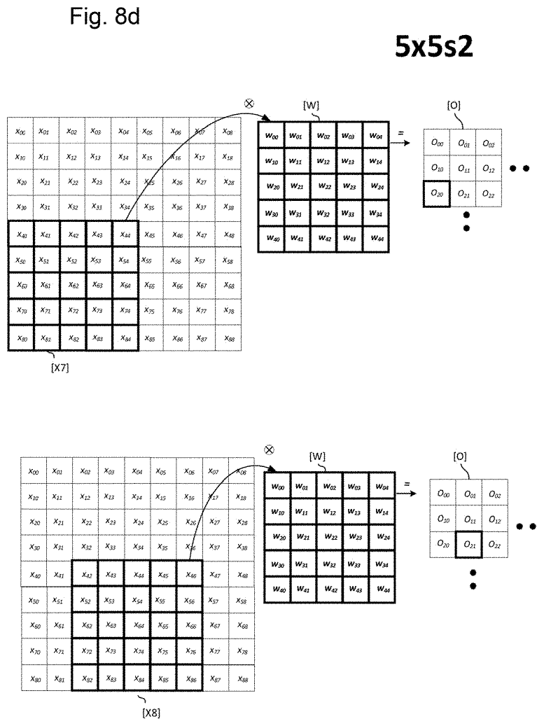

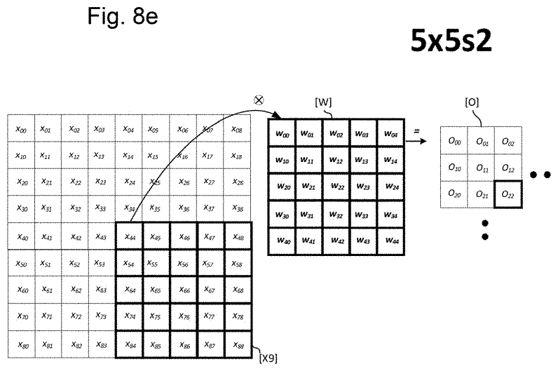

FIGS. 8a to 8e show convolution operations that may be carried out with a row and column spatial parallelism by the computing network according to one embodiment, to obtain one portion of the output matrix [O] output on an output channel from an input matrix input on an input channel, during a 5×5s2 convolution.

In FIGS. 8a to 8e, only that portion of an input matrix [I] composed of submatrices (or neuron receptive fields) which overlaps with the submatrix [X1] has been shown. This results in the use of at the least one input datum xᵢⱼ common to the submatrix [X1]. Thus it, it is possible for various groups Gⱼ of computing units, which are composed of a single computing unit PE₀ in this illustrative example, to carry out computations using these common input data.

The obtained portion of the input matrix [I] that may be used with a spatial parallelism to carry out a 5×5s2 convolution is a matrix of 9×9 size composed of 9 “neuron receptive fields” giving, by convolution with the weight matrix [W], nine output results O₀₀ to O₈₈. It is thus possible to compute a 5×5s2 convolutional layer with a computing network composed of 3×3 groups Gⱼ of computing units.

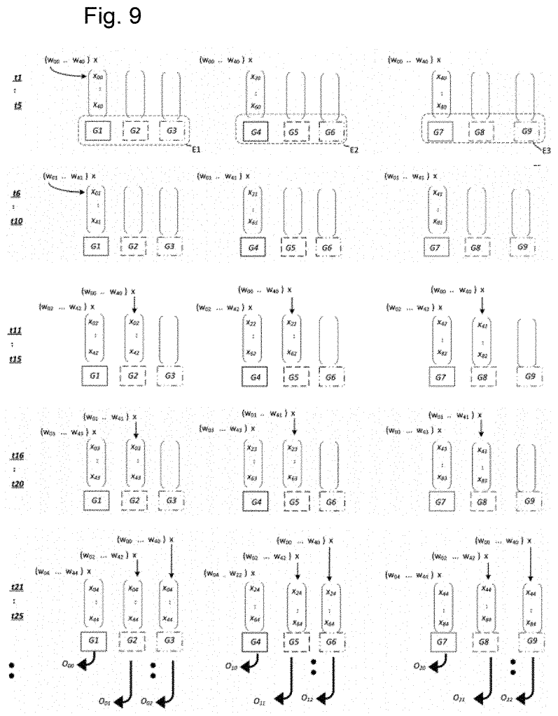

FIG. 9 illustrates operating steps of a computing network according to the second mode of computation with “a row and column spatial parallelism” of the invention for computing a 5×5s2 convolutional layer. However, this type of convolution requires more computation cycles (2×5 computation cycles) to scan two successive columns of an input submatrix in the course of computation.

Regarding the computation of a 5×5s1 convolutional layer, the number of output results Oᵢⱼ able to be computed via a row and column spatial parallelism is 25, which is higher than 9. Thus, the computer according to the described embodiment (3 sets containing 3 groups of computing units) allows the computation of this type of convolution to be carried out but with four reads of the input data.

Other computation-programming techniques may be envisioned by the designer to adapt the chosen embodiment (defining the number of sets and the number of groups) to the type of convolution carried out.

Advantageously, to introduce a row and column spatial parallelism, a 5×5s1 convolutional layer may be computed by a computing network MAC_RES composed of 5 computing sets E1 to E5 such that each set itself comprises 5 groups Gⱼ of computing units, each group Gⱼ of computing units comprising Q computing units PEᵢ. This variant of the invention allows an optimised operation with the 5×5s1 convolution.

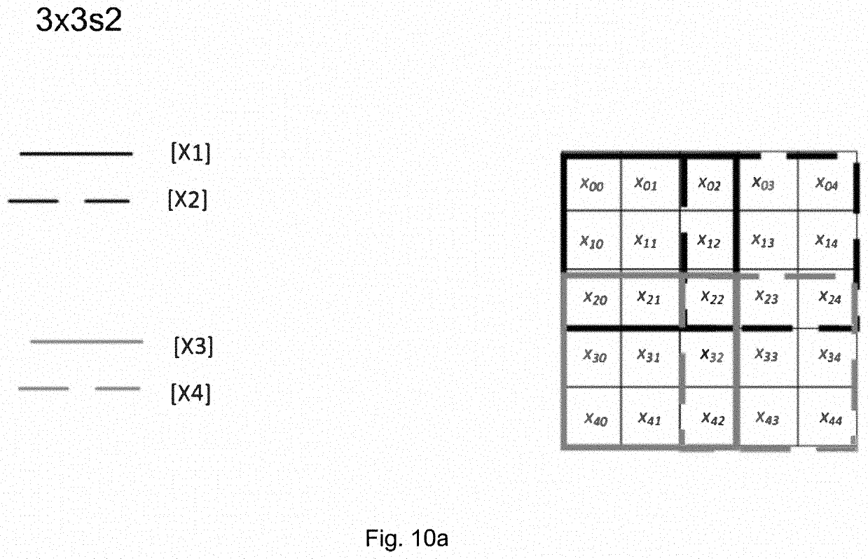

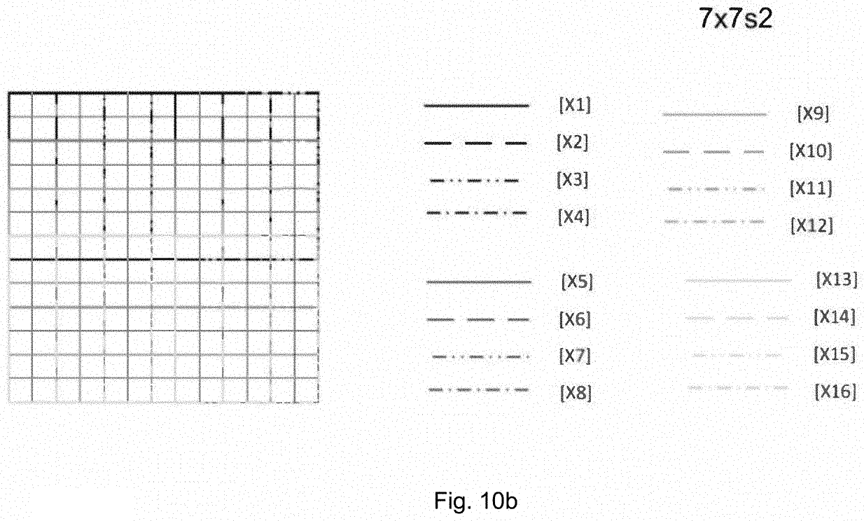

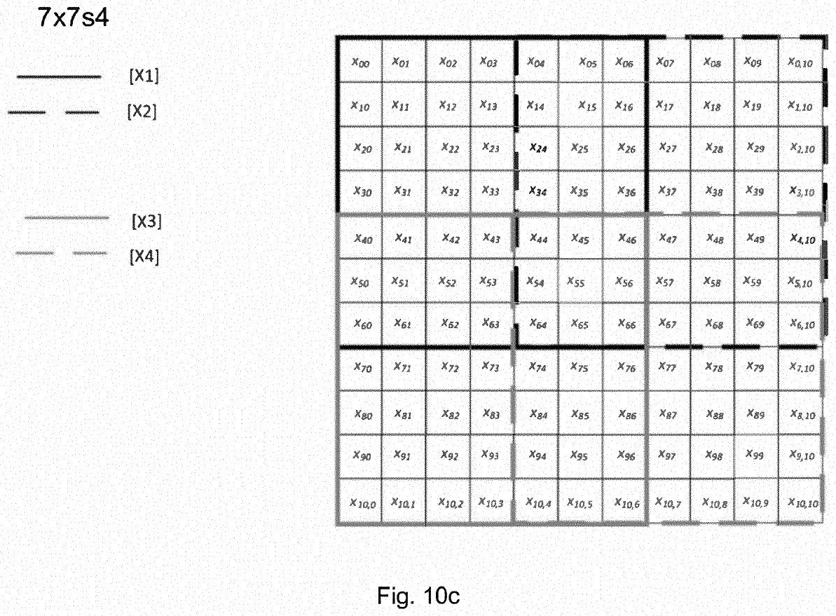

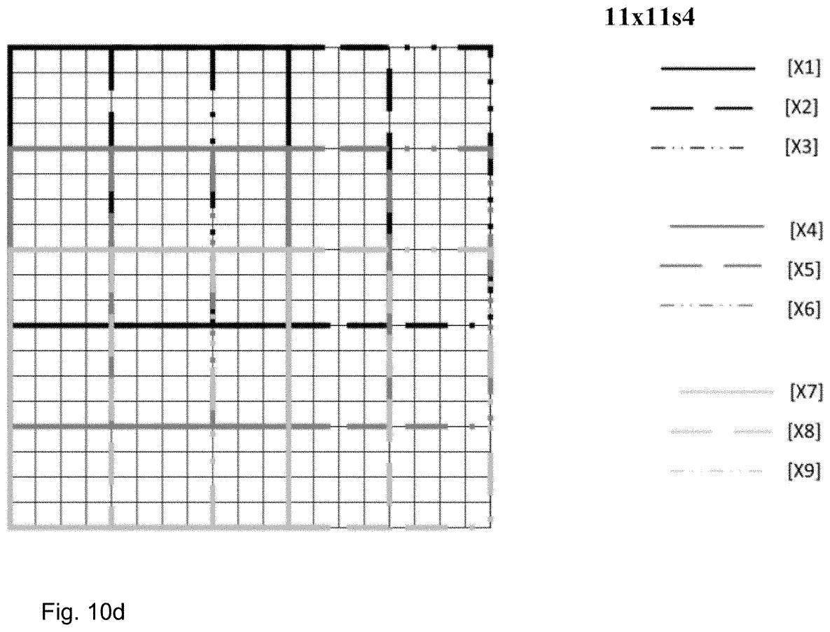

FIG. 10a shows convolution operations that may be carried out with a spatial parallelism by the computing network according to one embodiment, to obtain one portion of the output matrix [O] output on an output channel from an input matrix input on an input channel, during a 3×3s2 convolution. The input submatrices having input data common with a submatrix [X1] are the submatrices [X2], [X3] and [X4]. Thus, it is possible to compute four output Oᵢⱼ results with a spatial computing parallelism using four groups Gⱼ of computing units. The embodiment of FIG. 4 comprises 9 groups Gⱼ of computing units, which are thus able to compute a 3×3s2 convolutional layer.

Advantageously, to introduce a row and column spatial parallelism into a 3×3s2 convolution while minimising the computation time of the circuit, it is possible to use 8 groups of computing units allowing 8 output results Oᵢⱼ to be computed with a spatial parallelism, rather than just four.

Advantageously, to introduce a row and column spatial parallelism into a 3×3s2 convolution while minimising the footprint and complexity of the circuit, a 3×3s2 convolutional layer may be computed by a computing network MAC_RES composed of 2 computing sets E1 to E2 such that each set itself comprises 2 groups Gⱼ of computing units, each group Gⱼ of computing units comprising Q computing units PEᵢ. This variant of the invention allows an optimised operation with the 3×3s2 convolution.

FIG. 10b shows convolution operations that may be carried out with a spatial parallelism by the computing network according to one embodiment, to obtain one portion of the output matrix [O] output on an output channel from an input matrix input on an input channel, during a 7×7s2 convolution. The input submatrices having input data common with a submatrix [X1] are the submatrices [X2], [X3], [X4], [X5], [X6], [X7], [X8], [X9], [X10], [X11], [X12], [X13], [X14], [X15] and [X16]. Thus, it is possible to compute 16 output results Oᵢⱼ with a spatial computing parallelism using sixteen groups Gⱼ of computing units. The embodiment of FIG. 4 comprises 9 groups Gⱼ of computing units, which are thus able to compute a 7×7s2 convolutional layer but with four reads of input data.

Advantageously, to introduce a row and column spatial parallelism, a 7×7s2 convolutional layer may be computed by a computing network MAC_RES composed of 4 computing sets E1 to E4 such that each set itself comprises 4 groups Gⱼ of computing units comprising Q computing units PEᵢ. This variant of the invention allows an optimised operation with the 7×7s2 convolution.

FIG. 10c shows convolution operations that may be carried out with a spatial parallelism by the computing network according to one embodiment, to obtain one portion of the output matrix [O] output on an output channel from an input matrix input on an input channel, during a 7×7s4 convolution. The input submatrices having input data common with a submatrix [X1] are the submatrices [X2], [X3] and [X4]. Thus, it is possible to compute four output results Oᵢⱼ with a spatial computing parallelism using four groups Gⱼ of computing units. The embodiment of FIG. 4 comprises 9 groups Gⱼ of computing units, which are thus able to compute a 7×7s4 convolutional layer.

Alternatively, to introduce a row and column spatial parallelism into a 7×7s4 convolution while minimising the footprint and complexity of the circuit, a 7×7s4 convolutional layer may be computed by a computing network MAC_RES composed of 2 computing sets E1 to E2 such that each set itself comprises 2 groups Gⱼ of computing units, each group Gⱼ of computing units comprising Q computing units PEᵢ. This variant of the invention allows an optimised operation with the 7×7s4 convolution.

FIG. 10d shows convolution operations that may be carried out with a spatial parallelism by the computing network according to one embodiment, to obtain one portion of the output matrix [O] output on an output channel from an input matrix input on an input channel, during an 11×11s4 convolution. The input submatrices having input data common with a submatrix [X1] are the submatrices [X2], [X3], [X3], [X4], [X5], [X6], [X7], [X8] and [X9]. Thus, it is possible to compute 9 output results Oᵢⱼ with a spatial computing parallelism using nine groups Gⱼ of computing units. The embodiment of FIG. 4 comprises 9 groups Gⱼ of computing units, which are thus able to compute an 11×11s4 convolutional layer.

In conclusion, the architecture of the computing network MAC_RES according to the invention, which comprises 3×3 groups Gⱼ of computing units, allows a plurality of types of convolutions, namely 3×3s2, 3×3s1, 5×5s2, 7×7s2, 7×7s4 and 11×11s4 convolutions, but also a 1×1s1 convolution, to be carried out in a mode of computation with “row and column spatial parallelism”. Alternatively, the architecture allows any type of convolution to be carried out in a mode of computation with “a row-only parallelism”. In addition, each group Gⱼ comprises 128 computing units PEᵢ allowing 128 output matrices [O]_{q} output on 128 output channels to be computed, thus introducing an output-channel computing parallelism. In the case where the number of output channels is higher than the number of computing units PEᵢ per group Gⱼ, the computer allows the computations of the various output channels to be carried out using the plurality of accumulators ACCᵢ of each computing unit PEᵢ.

The circuit CALC for computing a convolutional neural network according to the embodiments of the invention may be used in many fields of application, and especially in applications in which a classification of data is used. The fields of application of the circuit CALC for computing a convolutional neural network according to the embodiments of the invention for example comprise video-surveillance applications with real-time recognition of individuals and interactive classification applications, such applications being implemented in smartphones in interactive classification apps, apps for fusing data in home surveillance systems, etc.

The circuit CALC for computing a convolutional neural network according to the invention may be implemented using hardware and/or software components. Software components may be provided in the form of a computer-program product on a computer-readable medium, which medium may be electronic, magnetic, optical or electromagnetic. All or some of the hardware elements may be provided, especially in the form of application-specific integrated circuits (ASICs) and/or field-programmable gate arrays (FPGAs) and/or in the form of neural circuits according to the invention or in the form of a digital signal processor (DSP) and/or in the form of a graphics processing unit (GPU) and/or in the form of a microcontroller and/or in the form of a general processor, for example. The circuit CALC for computing a convolutional neural network also comprises one or more memories, which may be registers, shift registers, RAMs, ROMs or any other type of memory suitable for implementing the invention.

1. A computing circuit (CALC) for computing output data (O_{i,j}) of a layer of an artificial neural network from input data (x_{i,j}), the neural network being composed of a succession of layers each consisting of a set of neurons, each layer being connected to one adjacent layer via a plurality of synapses associated with a set of synaptic coefficients (w_{i,j}) forming at least one weight matrix ([W]_{p,q}); the computing circuit (CALC) comprising:
an external memory (MEM_EXT) for storing all the input and output data of all the neurons of at least one layer of the network in the course of computation;
an integrated system on chip (SoC) comprising:
i. a computing network (MAC_RES) comprising at least one set (E1,E2,E3) of at least one group of computing units (Gⱼ) of rank j=0 to M with M a positive integer;
each group (Gⱼ) comprising at least one computing unit (PEₙ) of rank n=0 to N with N a positive integer for computing a sum of input data weighted by the synaptic coefficients;
the computing network (MAC_RES) further comprising a buffer memory (BUFF) for storing a submatrix of input data originating from the memory (MEM_EXT); the buffer memory (BUFF) being connected to the computing units (PEₙ);
ii. a weight-storing stage (MEM_POIDS) comprising a plurality of memories (MEM_POIDSₙ) of rank n=0 to N for storing the synaptic coefficients of the weight matrices ([W]_{p,q}); each memory (MEM_POIDSₙ) of rank n=0 to N being connected to all the computing units (PEₙ) of the same rank n of each of the groups (G);
iii. control means (ADD_GEN, ADD_GEN2) configured to distribute the input data (x_{i,j}) from the buffer memory (BUFF) to said sets (E1,E2,E3) so that each set (E1,E2,E3) of groups of computing units receives a column vector of the submatrix stored in the buffer memory (BUFF) incremented by one column with respect to the column vector received previously; all the sets (E1,E2,E3) simultaneously receive column vectors that are shifted with respect to each other by a number of rows equal to a stride of the convolution operation;
the output data (Oᵢⱼ) of a layer are organised into a plurality of output matrices ([O]_{q}) of rank q=0 to Q with Q a positive integer, each output matrix being associated with an output channel of same rank q;
each synaptic coefficient of the weight matrix ([W]_{p,q}) associated with said output channel is stored solely in the weight memory (MEM_POIDSₙ) of rank n=0 to N+1 such that q modulo N+1 is equal to n.

2. The computing circuit (CALC) according to claim 1, wherein the control means (ADD_GEN, ADD_GEN1) are furthermore configured to organise the read-out of the synaptic coefficients (w_{i,j}) from the weight memories (MEM_POIDSₙ) to said sets (E1,E2,E3).

3. The computing circuit (CALC) according to claim 1, wherein the control means are implemented via a set of address generators (ADD_GEN, ADD_GEN1, ADD_GEN2).

4. The computing circuit (CALC) according to claim 1, wherein the integrated system on chip (SoC) comprises an internal memory (MEM_INT) to be used as an extension of the external volatile memory (MEM_EXT); the internal memory (MEM_INT) being connected to write to the buffer memory (BUFF).

5. The computing circuit (CALC) according to claim 1, wherein:
the control means (ADD_GEN) are configured to organise the output data (O_{i,j}) in the buffer memory (BUFF) so that the output data (Oᵢⱼ) of a layer are organised into a plurality of output matrices ([O]_{q}) of rank q=0 to Q with Q a positive integer, each output matrix being obtained from at least one input matrix ([I]ₚ) of rank p=0 to P with P a positive integer,
the control means (ADD_GEN2) are configured to organise the synaptic coefficients (w_{i,j}) in the weight-storing stage (MEM_POIDS) so that, for each pair consisting of an input matrix of rank p and an output matrix of rank q, the associated synaptic coefficients (w_{i,j}) form a weight matrix ([W]_{p,q}^{k}),
each computing unit (PEₙ) is able to generate one output datum (O_{i,j}) of the output matrix ([O]_{q}), by computing the sum of the input data of a submatrix ([X1], [X2], [X3], [X4], [X5], [X6], [X7], [X8], [X9]) of the input matrix ([I]ₚ) weighted by the associated synaptic coefficients,
the control means (ADD_GEN, ADD_GEN2) are configured to organise the output data (Oi,j) in the buffer memory (BUFF) so that the input submatrices ([X1], [X2], [X3], [X4], [X5], [X6], [X7], [X8], [X9]) have the same dimensions as the weight matrix ([W]_{p,q}^{k}) and so that each input submatrix is obtained by applying a shift equal to the stride of the convolution operation carried out in the row or column direction to an adjacent input submatrix.

6. The computing circuit (CALC) according to claim 1, wherein each computing unit comprises:
i. an input register (Reg_in₀, Reg_in₁, Reg_in₂, Reg_in₃) for storing an input datum (x_{i,j});
ii. a multiplier circuit (MULT) for computing the product of an input datum (x_{i,j}) and of a synaptic coefficient (w_{i,j});
iii. an adder circuit (ADD₀, ADD₁, ADD₂, ADD₃) having a first input connected to the output of the multiplier circuit (MULT₀, MULT₁, MULT₂, MULT₃) and being configured to perform the operations of summing partial results of computation of a weighted sum;
iv. at least one accumulator (ACC₀⁰, ACC₁⁰, ACC₂⁰) for storing the partial or final results of computation of the weighted sum.

7. The computing circuit (CALC) according to claim 1, wherein each weight memory (MEM_POIDS0, MEM_POIDS1, MEM_POIDS2, MEM_POIDS3) of rank n=0 to N contains all of the synaptic coefficients (w_{i,j}) belonging to all the weight matrices ([W]_{p,q}) associated with the output matrix ([O]_{q}) of rank q=0 to Q such that q modulo N+1 is equal to n.

8. The computing circuit (CALC) according to claim 1, introducing a parallelism into computation of output channels, this parallelism being such that the computing units (PEₙ) of rank n=0 to N of the various groups of computing units (Gⱼ) carry out the multiplication and addition operations to compute an output matrix ([O]_{q}) of rank q=0 to Q such that q modulo N+1 is equal to n.

9. The computing circuit (CALC) according to claim 1, wherein each set (E1,E2,E3) comprises a single group of computing units (Gⱼ), each computing unit (PE) comprising a plurality of accumulators (ACC₀⁰, ACC₁⁰, ACC₂⁰); each set (E1,E2,E3) of rank k with k=1 to K with K a strictly positive integer, being configured to carry out successively, for a received input datum (x_{i,j}), the addition and multiplication operations to compute partial output results (O_{i,j}) belonging to a row of rank i=0 to L, with L a positive integer, of the output matrix ([O]_{q}) from said input datum (x_{i,j}), such that i modulo K is equal to (k−1).

10. The computing circuit (CALC) according to claim 9, wherein the partial results of each of the output results (O_{i,j}) of the row of the output matrix computed by a computing unit (PEₙ) are stored in a separate accumulator belonging to the same computing unit (PEₙ).

11. The computing circuit (CALC) according to claim 1, wherein each set (E1, E2, E3) comprises a plurality of groups of computing units (Gⱼ) introducing a spatial parallelism into computation of the output matrix ([O]_{q})
such that each set (E1,E2,E3) of rank k with k=1 to K carries out in parallel the addition and multiplication operations to compute partial output results (O_{i,j}) belonging to a row of rank i of the output matrix ([O]_{q}), such that i modulo K is equal to (k−1) and such that each group (Gⱼ) of rank j=0 to M of said set (E1, E2, E3) carries out the addition and multiplication operations to compute partial output results (O_{i,j}) belonging to a column of rank I of the output matrix ([O]_{q}) such that I modulo M+1 is equal to j.

12. The computing circuit (CALC) according to claim 11 comprising three sets (E1, E2, E3), each set comprising three groups of computing units (G1, G2, G3).

13. The computing circuit (CALC) according to claim 1, wherein the weight memories (MEM_POIDSₙ) are of NVM type.
